(19) United States
(12) Patent Application Publication
(10) Pub. No.: US 2022/0362896 A1
(43) Pub. Date: Nov. 17, 2022

(54) LOADING OR UNLOADING DEVICE AND LOADING OR UNLOADING SYSTEM FOR USE WITH ONE OR MORE MACHINE TOOLS

(71) Applicant: DECKEL MAHO Pfronten GmbH, Pfronten (DE)

(72) Inventors: Axel KIENBERGER, Pfronten (DE); Michael TRENKLE, Pfronten (DE); Matthias MAYR, Füssen (DE)

(21) Appl. No.: 17/642,927

(22) PCT Filed: Sep. 14, 2020
(86) PCT No.: PCT/EP2020/075662

§ 371 Date: Mar. 14, 2022

(30) Foreign Application Priority Data
Sep. 16, 2019 (DE) 10 2019 214 081.5

(51) Int. Cl. B23Q 3/155; B65G 69/00

(52) U.S. Cl. CPC B23Q 3/15513; B65G 69/006; B23Q 3/15539

(57) ABSTRACT

The invention relates to a loading or unloading device (500) for use with a machine tool (100), comprising: a transport vehicle (510) that can move freely in an area; a handover unit (540) arranged on the transport vehicle (510) and having a receiving section (530) which in turn has a plurality of retaining sections arranged in a row for receiving tools (WZ) or tool interfaces (WZS) holding tools and/or workpieces; and one or more docking sections arranged on the transport vehicle (510) for docking and/or workpieces on the machine tool, in particular of a supply unit (400) of a tool and/or workpiece magazine (200) of the machine tool.

The present invention relates to an unloading or loading device or an unloading or loading system for use with one or more machine tools. In particular, the present invention relates to an unloading or loading device for loading or unloading a tool and/or workpiece magazine of the machine tool(s) with tools and/or workpieces and/or an unloading or loading system for loading or unloading tools and/or workpiece magazines of machine tools with tools and/or workpieces. Furthermore, the present invention relates to a system comprising a machine tool, a tool and/or workpiece changing device, a supply unit and/or a tool or workpiece magazine of a machine tool, preferably including such an unloading or loading device of the system.

### BACKGROUND

Machine tools with tool or workpiece magazines on which tools and/or workpieces are held or provided so that they can be exchanged automatically from the magazine on the machine tool or transferred from the machine tool to the magazine are known in the prior art.

For example, reference is made to EP 2 750 828 B1 which describes a generic tool changing device on a tool magazine of a machine tool. EP 2 750 828 B1 shows a tool changing device for use on a machine tool with a horizontally aligned work spindle, wherein a tool can be removed by means of a manipulator on a tool magazine having one or more tool magazine wheels (so-called wheel magazine) and can be used on the work spindle or can be exchanged with a tool used on the work spindle.

However, according to EP 2 750 828 B1, it was still planned that the tool or workpiece magazine is loaded manually. DE 10 2018 201 426 A1 discloses a supply unit for a tool magazine of a machine tool, the supply unit allowing for a tool or workpiece magazine to be loaded in a semi-automated manner, e.g. according to EP 2 750 828 B1. Here, an additional tool bar is provided, which can be loaded manually by an operator. The tool bar with manually loaded tools may then be lifted and rotated from the loading position accessible by the operator to a handover position via a lifting and rotating device of the supply unit so that the manipulator of the tool changing device can automatically remove tools from the tool bar positioned at the handover position and can supply them at the magazine or at the machine tool.

Proceeding from the prior art described above, for example according to DE 10 2018 201 426 A1, it is an object of the present invention to enable improved, more efficient and/or more precise loading of workpieces or tools on a machine tool, in particular particularly expediently with further improved or expanded automation of the loading or unloading process, or particularly preferably with a fully automated configuration.

### SUMMARY

In order to achieve the above object, an unloading or loading device for use on a machine tool according to claim 1 is proposed according to the invention. Furthermore, a system having a machine tool and/or a tool or workpiece magazine comprising such an unloading or loading device is proposed according to the invention. Dependent claims relate to preferred embodiments of the present invention.

According to one aspect, an unloading or loading device for use on a machine tool is proposed, comprising a transport vehicle that can be moved freely in an area, and is particularly preferably powered.

In expedient exemplary embodiments, the unloading or loading device may have a handover unit arranged on (preferably on the front or on the side of) the transport vehicle and having a receiving section, in particular for receiving tools and/or workpieces.

In expedient exemplary embodiments, the transport vehicle may be a (trackless) industrial truck (such as, for example, a lift truck with an electric drive) including at least one receiving unit (such as, for example, a fork), wherein the handover unit rests on the receiving device directly or via one or more intermediate elements and/or or is detachably connected to the receiving unit or the intermediate elements.

In expedient exemplary embodiments, the receiving section may include a plurality of retaining sections, preferably arranged in a row, for receiving tools or tool interfaces holding tools and/or workpieces.

In expedient exemplary embodiments, the receiving section may also include a plurality of retaining section rows (i.e., a plurality of rows of retaining sections arranged in a row), the retaining section rows preferably being arranged on the sides of the receiving section.

In expedient exemplary embodiments, the unloading or loading device may include one or more docking sections arranged on (preferably on the front or on the side of) the transport vehicle for docking to one or more docking sections of a supply unit for tools and/or workpieces on the machine tool, in particular a supply unit for a tool and/or workpiece magazine of the machine tool include.

In expedient exemplary embodiments, the row of retaining sections of the receiving section may extend in the transverse direction with respect to the transport vehicle or transversely to a direction of travel of the transport vehicle. The retaining sections are preferably arranged next to one another in a row in the transverse direction or in a direction transverse to the direction of travel of the transport vehicle.

In a further embodiment, the handover unit may include a rotation device (preferably mounted horizontally and/or arranged centrally on the handover unit) having a vertical axis of rotation, which preferably carries the receiving section and can rotate the retaining sections by a predeterminable (horizontal) angle of rotation. The unloading or loading device may also preferably include a receiving section of the handover unit including a large number of retaining sections, wherein the individual retaining sections can be rotated together by the rotation device of the handover unit and wherein, by rotation of the retaining sections (or the row of retaining sections), a plurality of tool removal and loading processes can be carried out.

In expedient exemplary embodiments, the retaining sections of the receiving section can preferably rotate at least about a vertical axis of rotation and can be moved at least linearly (in particular transversely to the direction of travel of the transport vehicle). In particular, the rotation and movement of the retaining sections may preferably be carried out in an automated or at least partially automated manner. In addition, the receiving section may be configured such that, by rotating and moving the plurality of retaining sections, a plurality of tool removal and handover processes that are executable sequentially can be carried out on a receiving section

In expedient exemplary embodiments, the transport vehicle may be configured, in order to dock to the docking section(s) of the supply unit in a direction of travel, with regard to which in particular the row of retaining sections of the receiving section may be oriented transversely, to approach the docking section(s) of the supply unit with the retaining section(s) facing the docking section(s) of the supply unit and/or the docking section(s) of the transport vehicle facing the docking section(s) of the supply unit.

In expedient exemplary embodiments, the docking section(s) of the transport vehicle may be configured to dock to the corresponding docking section(s) of the supply unit, particularly preferably when the transport vehicle approaches the docking section(s) of the supply unit with the retaining section(s) facing the docking section(s) of the supply unit and/or the docking sections of the transport vehicle facing the docking sections of the supply unit.

In expedient exemplary embodiments, the docking section(s) of the transport vehicle may be configured to dock with the corresponding docking section(s) of the supply unit via a mechanical connection blocking at least movement in the direction of travel of the transport vehicle and/or a stop contact, in particular in a manner form-fittingly blocking in the direction of travel, wherein particularly preferably, in the docked state, a position alignment of the handover unit in the direction of travel of the transport vehicle and/or transverse thereto can be established.

In expedient exemplary embodiments, the docking section(s) of the transport vehicle may be configured to dock to the corresponding docking section(s) of the supply unit via a mechanical connection blocking at least horizontal movement transverse to the direction of travel of the transport vehicle, in particular in a manner form-fittingly blocking horizontally laterally or transversely to the direction of travel, wherein particularly preferably, in the docked state, a lateral position alignment of the handover unit transversely to the direction of travel of the transport vehicle can be established.

In expedient exemplary embodiments, the docking section(s) of the transport vehicle may be configured to dock with the corresponding docking section(s) of the supply unit via a mechanical connection blocking in one or more directions transverse to the direction of travel of the transport vehicle, in particular in a manner form-fittingly blocking transversely to the direction of travel, wherein particularly preferably, in the docked state, a position alignment of the handover unit in one or more directions transverse to the direction of travel of the transport vehicle can be established.

In expedient exemplary embodiments, the docking section(s) of the transport vehicle may be configured to dock with the corresponding docking section(s) of the supply unit via an unlockable or lockable mechanical connection, in particular in a manner form-fittingly blocking transversely to the direction of travel, wherein particularly preferably, in the docked state, a positional locking of the handover unit and/or an element connected to the handover unit can be established.

In expedient exemplary embodiments, the handover unit may include a carriage that can be moved linearly in the direction of travel of the transport vehicle and/or in a direction transverse to the row of retaining sections of the receiving section, said carriage preferably carrying the receiving section, particularly preferably for moving the receiving section towards or away from the supply unit in the docked state.

In expedient exemplary embodiments, the linearly movable carriage may also be oriented opposite to the direction of travel of the transport vehicle and/or preferably carry the entire handover unit or an element used by the handover unit to rest thereon.

In expedient exemplary embodiments, the handover unit may include stopper sections, guide sections and/or docking elements, in particular stopper sections, guide sections and/or docking elements connecting in a form-fitting manner, which preferably block the movement of the carriage in the opposite direction to the direction of travel of the transport vehicle in a self-centered and/or locked transport state.

In expedient exemplary embodiments, the handover unit may include a first carrier section, which preferably carries the receiving section directly or indirectly, particularly preferably via a movable carriage carried by the first carrier section and/or carrying the receiving section.

In expedient exemplary embodiments, the first carrier section may carry the handover unit, preferably via a (preferably centrally arranged) rotation device, in particular via a controllable (and preferably horizontally oriented) turntable, rotary unit, or rotary mechanism, wherein the rotation device may be connected to both the handover unit and the first carrier section and the handover unit may be rotatably mounted, at least on a horizontal plane. In expedient exemplary embodiments, the handover unit may include a second carrier section which may preferably be arranged at or attached to the transport vehicle in a stationary manner with respect to the docking section(s) of the transport vehicle.

In expedient exemplary embodiments, the second carrier section may carry the first carrier section, and/or the first carrier section may be mounted on the second carrier section in a floating manner such that it can be moved in at least one horizontal direction and/or be mounted such that it can be displaced (guided) in at least one horizontal direction.

In expedient exemplary embodiments, the second carrier section may also be movably mounted, preferably in particular by a guide device oriented in parallel to the direction of travel of the first carrier section, wherein the movement of the first and second carrier sections may preferably be carried out in parallel. The displacement devices for moving the first and second carrier sections may preferably be configured such that the movement of one of the carrier sections can be used for rapid adjustment and movement of the handover unit and the movement of the other carrier section can be used for precise fine adjustment and movement. In expedient exemplary embodiments, the docking section may be attached to the second carrier section, preferably laterally and/or transversely to the direction of travel of the transport vehicle, and, by moving the second carrier section by means of the guide device of the second carrier section, can be moved up to the docking section of the supply unit or be moved away from the latter.

In expedient exemplary embodiments, the first carrier section may be mounted on the second carrier section in a floating manner such that it can be moved and/or displaced (guided) at least in the direction of travel of the transport vehicle.

In expedient exemplary embodiments, the handover unit may include stopper sections, guide sections and/or docking elements, in particular stopper sections, guide sections and/or docking elements connecting in a form-fitting manner, which can preferably block the movement of the first carrier section relative to the second carrier section in the direction of travel of the transport vehicle in a self-centered and/or locked transport state.

In expedient exemplary embodiments, the handover unit may include stopper sections, guide sections and/or docking elements, in particular stopper sections, guide sections and/or docking elements connecting in a form-fitting manner, which preferably can block the movement of the second carrier section relative to the first carrier section, in or transversely to the direction of travel of the transport vehicle, in a self-centered and/or locked transport state.

In expedient exemplary embodiments, the first carrier section may be mounted on the second carrier section in a floating manner, preferably at least transversely to the direction of travel of the transport vehicle.

In expedient exemplary embodiments, the handover unit may include stopper sections, guide sections and/or docking elements, in particular stopper sections, guide sections and/or docking elements connecting in a form-fitting manner, which can preferably block the movement of the first carrier section relative to the second carrier section in a self-centered and/or locked transport state, preferably transverse to the direction of travel of the transport vehicle.

In expedient exemplary embodiments, the handover unit may include a biasing mechanism which preferably biases the first carrier section relative to the second carrier section in the self-centered and/or locked transport state or can exert a force acting on the second carrier section towards a position of the second carrier section establishing a self-centered and/or locked transport state.

In expedient exemplary embodiments, the transport vehicle may be configured as a driverless transport vehicle, wherein the transport vehicle particularly preferably includes a control unit and/or a communication unit for wireless connection to an external control unit for driverless control of the transport vehicle.

In expedient exemplary embodiments, the transport vehicle may be driven at least for translation, particularly preferably by means of a drive for a translation movement of the transport vehicle.

In expedient exemplary embodiments, the transport vehicle may have automated steering assistance and/or steering control.

In a further aspect, a system is proposed, comprising a supply unit for use on a tool and/or workpiece magazine for a machine tool and/or an unloading or loading device according to one of the above aspects or also individual features of the exemplary embodiments described below.

The system may also comprise the machine tool (or a plurality of machine tools), a tool or workpiece changing device and/or the tool and/or workpiece magazine. In addition, an unloading or loading station for the transport vehicle, which may include an analogously configured supply unit, may be provided.

In expedient exemplary embodiments, the transport vehicle of the unloading or loading device may be configured to dock to one or more docking sections of the supply unit for loading or unloading the loading bar of the supply unit, particularly preferably in a partially or fully automated manner.

In expedient exemplary embodiments, the supply unit may include a loading bar which can be brought into a loading position and comprises a row of workpiece and/or tool receptacles.

The handover unit of the unloading or loading device may preferably be configured, in the docked state, to handover or insert and/or pick up or remove workpieces and/or tools at the workpiece and/or tool receptacles of the loading bar at the loading position, in particular in a manner partially or fully automated.

Further aspects and their advantages as well as advantages and more specific implementation options of the aspects and features described above are described in the following descriptions and explanations of the accompanying figures and corresponding exemplary embodiments and exemplary variants of embodiments, which are not to be understood as restrictive in any way.

### BRIEF DESCRIPTION OF THE DRAWINGS

FIGS. 1A and 1B show exemplary perspective illustrations of a tool magazine of a machine tool with an unloading and loading device according to an exemplary embodiment of the invention;

FIG. 2 shows an exemplary perspective illustration of a tool bar (loading bar) at a handover position of the supply unit of the tool magazine of the machine tool according to an embodiment of the invention;

FIG. 3 shows an exemplary perspective illustration of a further exemplary embodiment of a supply trolley or transport vehicle of an unloading or loading device according to an exemplary embodiment of the invention;

FIGS. 4A and 4B show exemplary perspective illustrations of a further exemplary embodiment of a supply trolley or transport vehicle of an unloading or loading device according to an exemplary embodiment of the invention;

FIGS. 5A and 5B show exemplary detailed perspective illustrations of a tool bar (loading bar) of the supply unit of the tool magazine of the machine tool according to an exemplary embodiment of the invention;

FIGS. 6A to 6F show exemplary perspective illustrations of a supply unit or handover unit of a supply trolley or transport vehicle of an unloading or loading device according to FIGS. 4A and 4B;

FIGS. 7A to 7L show exemplary perspective illustrations of the supply trolley or transport vehicle according to FIGS. 4A and 4B to illustrate an exemplary loading process;

FIGS. 8A to 8J show exemplary perspective illustrations of the supply trolley or transport vehicle according to FIGS. 4A and 4B to illustrate an exemplary unloading process;

FIG. 9 shows an exemplary perspective illustration of a production system including a plurality of machine tools and a driverless transport system (AGV) with respective unloading and loading devices according to an embodiment of the invention;

FIG. 10 shows an exemplary perspective view of a supply station of a production system with a driverless transport system (DTS) with respective unloading and loading devices according to an embodiment of the invention;

FIG. 11 shows an exemplary perspective illustration of a further exemplary embodiment of a supply trolley or transport vehicle of an unloading or loading device according to an exemplary embodiment of the invention; and

FIG. 12 shows an exemplary perspective illustration of a further exemplary embodiment of a supply trolley or transport vehicle of an unloading or loading device according to an exemplary embodiment of the invention.

FIGS. 13A to 13D show an exemplary perspective illustration of a further exemplary embodiment of a supply trolley or transport vehicle of an unloading or loading device according to an exemplary embodiment of the invention

### DETAILED DESCRIPTION OF THE ACCOMPANYING FIGURES AND EXEMPLARY EMBODIMENTS OF THE PRESENT INVENTION

In the following, examples or exemplary embodiments of the present invention are described in detail with reference to the accompanying figures. Identical or similar elements in the figures may be denoted by the same reference symbols, but sometimes also by different reference symbols.

It should be noted that the present invention is in no way limited or restricted to the exemplary embodiments described below and implementation features thereof, but also includes modifications of the exemplary embodiments, in particular those included within the scope of the independent claims by modifying the features of the examples described or by combination of one or more of the features of the examples described.

In addition, it should be noted that, in the following, exemplary embodiments of an unloading or loading device for use on a machine tool associated with the unloading or loading of tools from/into a tool magazine are described merely by way of example.

However, the present invention relates to unloading or loading devices for loading and unloading tools and/or workpieces at a tool and/or workpiece magazine of the machine tool. Thus, further exemplary embodiments may be provided in which, analogously to the following exemplary embodiments, unloading and loading devices are provided for use on a machine tool associated with the unloading and loading workpieces from/into a workpiece magazine. In addition, the present invention may also be used for loading or unloading workpiece or component magazines on a machine tool or for loading or unloading hybrid magazines retaining tools and workpieces/components.

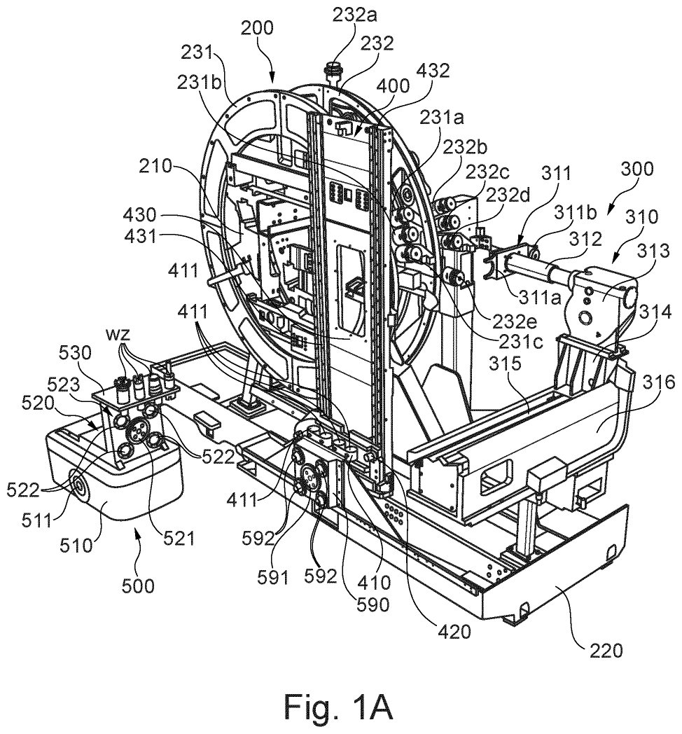

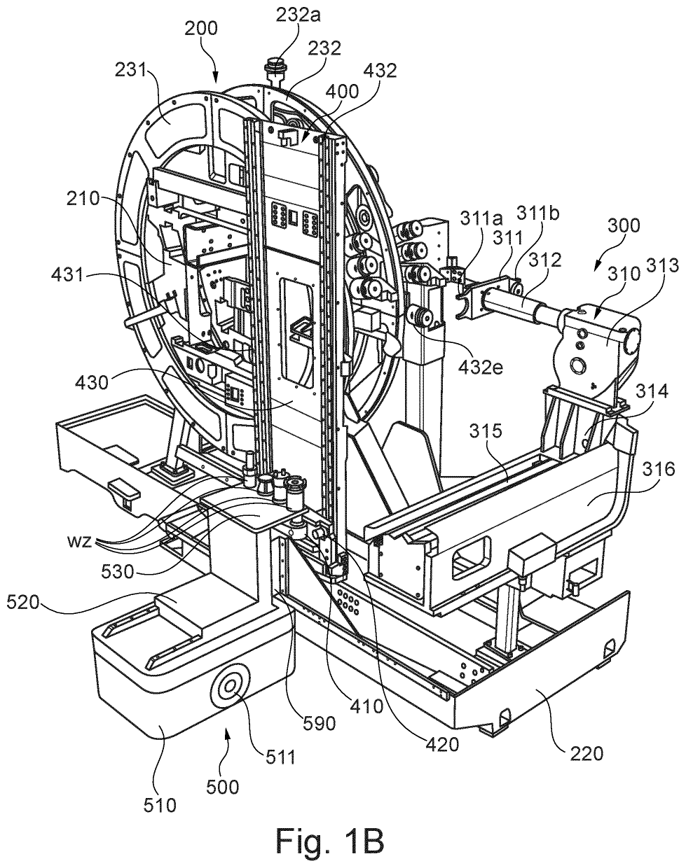

FIGS. 1A and 1B show exemplary perspective illustrations of a tool magazine 200 of a machine tool (not shown) including an unloading or loading device 500 according to an exemplary embodiment of the invention.

The tool magazine 200 comprises, for example, a magazine frame 210 which is arranged on a magazine tray 220 and rotatably holding, for example, two magazine wheels 231 and 232. The tool magazine 200 is thus configured as a wheel magazine, as an example.

Each of the magazine wheels 231 and 232 includes, for example, workpiece receptacles arranged circumferentially for receiving the respective tools. Thus, the first magazine wheel 231 includes, for example, tool receptacles 231a to 331c arranged circumferentially and the second magazine wheel 232 includes tool receptacles 232a to 232e arranged circumferentially, for example. Each tool receptacle is configured to receive a respective tool or a tool interface holding a tool, in particular with a radial receiving direction relative to the respective magazine wheel 231 or 232, for example. Tools are therefore oriented radially relative to the respective magazine wheel on the respective tool receptacles—i.e. with a radially aligned tool axis—and can respectively be removed radially.

For example, the tool magazine 200 is configured such that magazine wheels 231 and 232 are aligned vertically and parallel to one another, with the magazine wheels 231 and 232 being able to be rotated. in particular about a common axis of rotation, preferably independently of one another, in particular to align the tool receptacles, e.g. for removal of tools by the manipulator 310 of a tool changing device 300 described later.

However, the present invention is not limited to such a wheel magazine. Rather, tool magazines with one magazine wheel or tool magazines with three or more magazine wheels may also be provided, see e.g. EP 2 750 828 B1. Furthermore, the present invention is not limited to tool magazines configured as wheel magazines, but may also be used for loading or unloading other magazines, such as chain magazines or shelf magazines.

For example, in FIGS. 1A and 1B a tool changing device 300 is shown. The tool changing device 300 is configured to remove tools from the tool magazine 200 (preferably automatically or under program control) and to insert them on the machine tool (not shown) or the work spindle of the machine tool or to supply tools removed from the machine tool to the tool magazine 200.

The tool changing device 300 includes, for example, a manipulator 310 with an interchangeable gripper 311 for gripping tools or tool interfaces holding tools, e.g. tool interfaces configured as hollow shank tapers (HSK), or steep taper or Morse taper interfaces. The interchangeable gripper 311 is configured, for example, as a pivotable double gripper with opposite gripper sections 311a and 311b.

The interchangeable gripper 311 is held on a manipulator housing 313 (manipulator body) via a lifting/pivoting axis 312, for example. The manipulator housing 313 includes drives for the lifting/pivoting axis 312 for driving a horizontal lifting movement of the interchangeable gripper 311 away from or towards the manipulator housing 313 (for example, axially with respect to the longitudinal extent of lifting/pivoting axis 312) and for a pivoting movement of the interchangeable gripper 311 about a pivot axis extending axially with the lifting/pivoting axis 312.

Moreover, the manipulator housing 313 is arranged, for example, on a linearly displaceable carriage 314 arranged displaceably on a linear guide 315, which is arranged horizontally for example, on a guide frame 316. The linear guide 315 is arranged, for example, horizontally and, in particular, parallel to the axis of rotation of the magazine wheels 231 and 232 of the tool magazine 200 so that the manipulator 310 or manipulator housing 313 arranged on the carriage 314 can be displaced, for example, horizontally and in parallel to the axis of rotation of the magazine wheels 231 and 232 of the tool magazine 200.

In order to remove a tool or a tool interface holding a tool from a tool receptacle of a magazine wheel 231 or 232, the manipulator 310 moves horizontally to the corresponding magazine wheel 231 or 232, for example with the interchangeable gripper 311 at the level of the axis of rotation of the magazine wheels 231 and 232, in order to grip a tool or the tool interface holding the tool on a tool receptacle arranged at the level of the axis of rotation of the magazine wheels 231 and 232 and to remove it from the corresponding tool receptacle with a lifting movement of the lifting/pivoting axis 312 towards the manipulator housing 313.

The manipulator 310, with the removed tool, may then move to the side of the machine tool (for example the right side in FIG. 1A), e.g. to the position according to FIG. 1A or 1B (also referred to as the tool change position) in order to insert the tool by means of a pivoting movement of the interchangeable gripper 311 and a lifting movement away from the manipulator housing 313 on the work spindle of the machine tool.

Analogously, after a corresponding pivoting movement of interchangeable gripper 311, a tool removed from the work spindle of the machine tool by means of a lifting movement of interchangeable gripper 311 towards the manipulator housing 313 can be placed back on a tool receptacle on a magazine wheel of the tool magazine 200 by moving the manipulator 310 by means of the carriage 314 horizontally on the linear guide 315 to the corresponding magazine wheel and the tool or depositing or inserting the tool or the tool interface holding the tool via a lifting movement away from the manipulator housing 313 on a free tool receptacle of the corresponding magazine wheel.

For supplying or loading the tool magazine 200 with tools, according to FIGS. 1A and 1B, a supply unit 400 according to an embodiment of the invention is provided. The supply unit 400 is arranged, for example, on the side of the tool magazine 200 facing away from the working area of the machine tool.

The supply unit 400 includes, for example, a loading bar 410, which in the present exemplary embodiment, in which tools are retained on the loading bar 410, may also be referred to as a tool bar. However, loading bars retaining workpieces or components or loading bars retaining tools and workpieces or components are also conceivable or expedient.

The loading bar 410 comprises, for example, a plurality of receptacles 411, in the present example of FIG. 1A four tool receptacles 411, for receiving a respective tool or a respective tool interface holding a tool. Here, the tool receptacles 411 are arranged, for example, in a row (extending, for example, in a straight line) which extends in the longitudinal direction on the upper side of the loading bar 410.

In further exemplary embodiments, the loading bar may also include fewer or preferably more than four tool receptacles 411. In addition, the tool receptacles may also be arranged in two or more rows (preferably extending in parallel).

In FIG. 1A, by way of example, the loading bar 410 is arranged at a loading position at which the loading bar 410 can be loaded with tools by tools being inserted on tool receptacles 411 of the loading bar 410 at the loading position. The loading bar 410 may also be unloaded at the loading position by tools being removed from tool receptacles 411 of the loading bar 410 at the loading position.

Here, the loading bar 410 in the loading position is oriented horizontally, for example. In addition, the loading bar 410 in the loading position extends, for example, adjacent to the outermost magazine wheel 231 of the tool magazine in parallel to the plane of the magazine wheels or perpendicular to the axis of rotation of the magazine wheels.

In exemplary embodiments, the machine tool or the tool magazine may include a machine or magazine housing, wherein it is then preferred that the loading bar 410 is accessible at least at the loading position, e.g. by the loading position being arranged on an open side or partially open side of the housing.

In particularly expedient exemplary embodiments, the loading position is arranged at a door of the machine or magazine housing (preferably configured as a sliding door), which can be opened and closed, preferably by means of an automated or even fully automated opening/closing mechanism.

By way of example, the supply unit 400 further comprises a guide frame 430 attached to the magazine frame 210, for example, with linear guides 431 and 432 extending vertically on the guide frame 430, for example. On the linear guides 431 and 432, for example, a lifting unit 420 (lifting/rotating unit) is held or guided such that it can be displaced vertically.

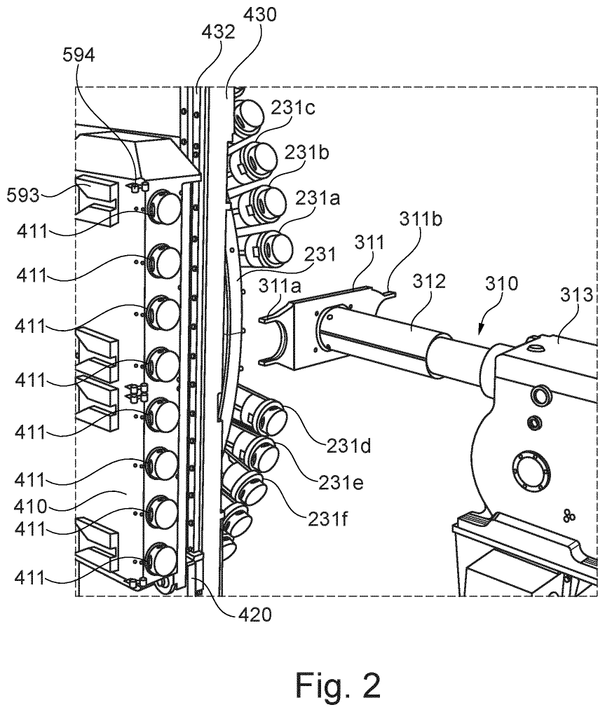

For example, the lifting unit 420 holds or carries the loading bar 410 and the lifting unit 420 is configured, for example, to move the loading bar 410 upwards from the loading position shown in FIG. 1A by moving it vertically on the linear guides 431 and 432, in particular towards a handover position of the supply unit (see, for example, FIG. 2).

In addition, the lifting unit 420 is configured, for example, to rotate the loading bar 410 about a horizontal axis of rotation in such a way that the loading bar 410, which is, e.g., horizontally oriented in the loading position, is rotated relative to the horizontal orientation in the handover position, particularly preferably in such a way that the loading bar 410 is oriented vertically in the handover position (see, for example, FIG. 2).

For example, the horizontal axis of rotation about which the lifting unit 420 can rotate the loading bar 410 is arranged perpendicular to the plane spanned by the linear guides 431 and 432 extending vertically, said plane being oriented in parallel to the planes of the magazine wheels or perpendicular to the axis of rotation of the magazine wheels of the tool magazine.

FIG. 2 shows an exemplary perspective illustration of a tool bar or loading bar 410 at a handover position according to an embodiment of the invention. Here, the loading bar 410 is configured differently from FIG. 1A and, according to the exemplary embodiment described further below, is provided with eight tool receptacles 411, for example, the tool receptacles 411 being arranged next to one another in a row, for example.

Due to the mode of operation of the exemplary embodiment described further below, the loading bar 410 in FIG. 2 includes, for example, additional docking elements 593 and additional positioning elements 594, which, however, are not required for the exemplary embodiment according to FIG. 1A. However, the principle of the handover at the handover position is identical or analogous in the exemplary embodiments.

Moreover, in FIG. 2, the tool receptacles 231a to 231f on the magazine wheel 231 are also shown as an example, with a gap (so-called free space) without a tool receptacle being provided on the magazine wheel 231 between the tool receptacles 231a and 231d, for example, in order to enable the manipulator 310 to move, with the interchangeable gripper 311, without collision through the gap between the tool receptacles 231a and 231d to the loading bar 410 located in the handover position. At least one such gap or free space is preferably provided on each magazine wheel.

The loading bar 410 is oriented vertically in the handover position, for example, and the tool receptacles 411 are arranged on the side of the tool magazine 200 facing the manipulator 310 or the tool changing device 300 in the handover position of the loading bar 410. The manipulator 310 may move to the handover position on the linear guide 315 in order to remove or insert a tool or a tool interface holding a tool on a tool receptacle 411 of the loading bar 410.

Since the manipulator 310 can move back and forth between the handover position and the tool change position and can also reach all magazine wheels in between, the manipulator 310 can bring tools from the loading bar 410 to each magazine wheel and also directly to the work spindle of the machine tool for a tool change in order to introduce the tool into the machining system of the machine tool, and the manipulator 310 can also take tools from the work spindle as well as from each magazine wheel and bring them to the loading bar 410 in the handover position in order to extract the tool from the machining system of the machine tool.

According to this exemplary embodiment (and also the other exemplary embodiments), the manipulator 310 moves, for example, at the level of the axes of rotation of the magazine wheels and can therefore access a tool receptacle 411 or a tool held on said tool receptacle 411 arranged at the level of the axes of rotation of the magazine wheels when the loading bar 410 is in the handover position (e.g., according to FIG. 2).

In order to enable the manipulator 310 to access another tool receptacle 411 of the loading bar 410 or a tool held on said other tool receptacle 411, the loading bar 410 can, while remaining in the vertical orientation at the handover position, be moved upwards or downwards by means of a mere lifting movement of the lifting unit 420 in order to align the desired tool receptacle 411 with the position at the level of the axis of rotation of the magazine wheels.

The lifting unit 420 is preferably configured to carry out the lifting and rotating movements of the loading bar 410 independently of one another. The lifting unit 420 is preferably configured to carry out the lifting and rotating movements of the loading bar 410 one after another or simultaneously. In particular, the lifting unit 420 is preferably configured to carry out the lifting movement of the loading bar 410 at the handover position without a rotating movement. In exemplary embodiments, a lifting axis driving the lifting movement and a rotary or pivoting axis driving the rotating or pivoting movement may be coupled or decoupled.

In this exemplary embodiment, the loading bar 410 is attached, for example, to the lifting unit 420 (lifting unit or lifting/rotating or lifting/pivoting unit) and is, for example, permanently installed. In further exemplary embodiments, the lifting unit 420 may also be configured to grip the loading bar 410 by means of an engaging device (e.g., according to the embodiment of DE 10 2018 201 426 A1).

It has previously been required that the loading bar 410 is to be equipped or loaded manually at the loading position. For this purpose, an operator must manually insert the tools individually on the tool receptacles 411 of the loading bar 410, with heavy workpieces possibly supported by an external crane system. This is expensive and wasting space. The following exemplary embodiments improve this situation significantly since a more efficient, faster, more accurate and safer loading option is provided, in particular providing further automation options.

Consequently, according to the invention and in contrast to the prior art, i.e. in contrast to DE 10 2018 201 426 A1, for example, it is not required that the loading bar 410 is manually loaded in the loading position by an operator, but the loading and unloading is provided with additional automation by providing a partially or fully automated unloading or loading device 500.

The unloading or loading device 500 includes, for example, a transport vehicle 510. In the exemplary embodiment according to FIGS. 1A and 1B, the transport vehicle 510 is configured as an example of a driverless transport vehicle 510 (abbreviation: FTF for driverless transport vehicle). In the English-speaking world, such a vehicle may also be referred to as an “Automated Guided Vehicle” or “Automatic Guided Vehicle” or AGV for short.

By the use of driverless transport vehicles, which are in contact, for example, with a central computer and/or control unit via radio, WLAN or the like, production processes can be controlled and automated even more effectively This also includes the optimization of the routes of the transport vehicles, scheduling with the machine tools/manufacturing centers, etc.

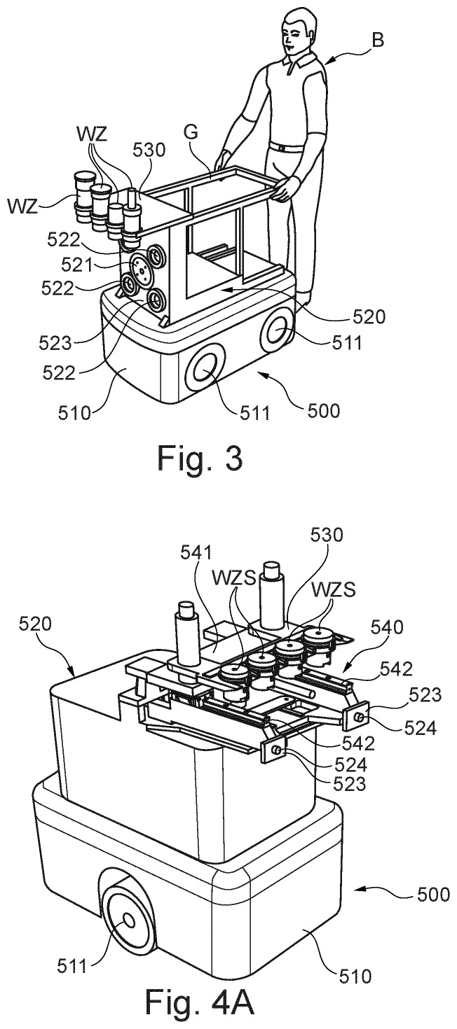

This is the preferred embodiment of the transport vehicle 510, wherein it is configured or implemented as a driverless transport vehicle or AGV of a driverless transport system. However, a driverless transport system does not necessarily have to be used, and any other vehicle may also be used as a transport vehicle. For example, the transport vehicle may also be configured as a manually steered or manually guided (but preferably powered) transport vehicle, see, e.g., FIG. 3.

The driverless transport vehicle 510, which can be moved freely (i.e. in particular not rail-bound or the like, for example) on a base area (e.g., a hall floor), includes driven wheels 511 and an internal drive for the wheels for example. In addition, the driverless transport vehicle 510 preferably internally includes a sensor and control system for controlling the driverless transport vehicle 510.

The wheels 511 may be connected to a central drive motor via a drive train (not shown), but they may also each have their own drive motor (e.g. one or more electric motors), which may be individually controlled, for example, by an internal control of the internal sensor and control system.

Furthermore, the wheels 511 may be articulated individually in preferred exemplary embodiments so that an extremely flexible driving style and positioning (for example turning on the spot, driving sideways, etc.) of the driverless transport vehicle 510 is enabled. However, the wheels 511 may also cause the driverless vehicle 510 to rotate by moving in opposite directions in order to achieve a positioning of the driverless vehicle 510.

Alternatively, instead of the wheels 511, chains or a crawler chassis or a combination of wheels and chains/crawler chassis may also be used in order to further increase the mobility or the flexibility of the driverless transport vehicle 510.

A particularly preferred embodiment of the wheels 511 are so-called Mecanum wheels. By simply controlling the direction of rotation of each wheel 511, they allow for a rotational movement of the transport device 510 on the spot, a translational movement of the transport device 510 both in the longitudinal direction (forwards, backwards) and in the transverse direction (sideways movement) of the transport device 510, as well as in a 45° angle with respect to the longitudinal or transverse direction.

By using Mecanum wheels, a steering mechanism for the wheels 511 may advantageously be completely eliminated and a corresponding positioning movement of the transport device 510 can be obtained solely with the internal control.

Furthermore, in exemplary embodiments, it may advantageously be possible for the transport vehicle 510 to be in contact (e.g. via radio, Bluetooth, WLAN, etc.) with the machine tool or a numerical machine control of the machine tool (or another specific destination), for example, in order to exchange information or signals directly with one another. This may also be carried out via a computer or control unit that is in contact with the transport vehicle 510 and the machine tool or a numerical machine control of the machine tool.

Moreover, the driverless transport vehicle 510 may also include an internal energy store, for which purpose an electrical energy store such as one or more, preferably rechargeable, batteries is used. However, the internal energy store is not limited to electrical energy, so that, if necessary, mechanical energy may also be stored in the form of, for example, pressurized fluids or deformation energy (e.g. a resilient element). Further energy stores for, e.g., hydraulics or pneumatics may also be accommodated in the chassis of the vehicle 510.

The driverless transport vehicle 510 according to FIG. 1A comprises, for example, on the top of the vehicle, an unloading and loading device 520 (e.g., a removable unloading and loading module) comprising a docking section 523 oriented forward (i.e., for example, pointing in the main direction of travel) with exemplary docking elements 521 and 522 and a tool retaining section 530 (receiving section) on which, for example, a plurality of tools WZ arranged in a row or tool interfaces holding a plurality of tools WZ arranged in a row are held. In other exemplary embodiments, workpieces or workpiece clamping means holding workpieces may also be held on the retaining section 530 (receiving section).

The tools WZ or tool interfaces are arranged, for example, in a horizontally oriented row and are held on the tool retaining section 530. The tools WZ are, for example, arranged on the tool retaining section 530 in such a way that they are held with their vertically aligned tool axis with the tool interface pointing downwards, for example in a row arranged perpendicular to the main direction of travel of the tool or in parallel to the forward-facing docking surface of the docking section.

In FIG. 1A, the tool interfaces are configured as hollow shank tapers (HSK), for example. The tool retaining section 530 thus includes, for example, a retaining section for receiving or retaining hollow shank taper tool interfaces. However, in further exemplary embodiments, the tool retaining section 530 may be configured to retain or receive other tool interfaces, such as, for example, steep tapers or Morse tapers.

In this exemplary embodiment, the loading device 500 includes, for example, a docking unit at the loading position of the supply unit 400, said docking unit being provided with a docking section 590 for docking with the corresponding docking section 523 of the unloading and loading device 520.

The driverless transport vehicle 510 is configured to approach the docking section 590 and to dock with the docking section 523 of the loading and unloading device 520.

In this case, the docking section 523 of the loading and unloading device 520 on the driverless transport vehicle 510 includes, for example, a central docking element 521 configured as a data interface or I/O link, which is configured to be connected to a corresponding central docking element 591 of the docking section 590 during docking.

Via the data interface or the I/O link of the docking elements 591 and 521 then connected, for example, the data directly or indirectly related to the corresponding tools (or workpieces and/or components) can be exchanged, e.g. the tool data (or workpiece and/or component data) associated with the tools (or workpieces and/or components) to be loaded or unloaded.

This may mean, for example, that the control unit of the driverless transport vehicle 510 transmits, when the transport vehicle 510 brings tools (or workpieces and/or components) to be loaded at the machine tool, via the data interface or the I/O link of the docking elements 591 and 521 then connected, tool data (or workpiece and/or component data) regarding the tools (or workpieces and/or components) brought to the machine control or to a computer-implemented machine tool operating unit, the data indicating information about the tools (or workpieces and/or components) brought such as tool identification numbers, information on tool type, tool size, tool model data, tool geometry, tool characteristics or tool wear status, etc. (or corresponding data on workpieces and/or components brought).

In the event that the driverless transport vehicle 510 unloads or picks up tools (or workpieces and/or components) from the machine tool, the machine control or a computer-implemented machine tool operating unit may transmit corresponding tool data (or workpiece data and/or component data) to the control unit of the driverless transport vehicle 510 via the data interface or the I/O link of the docking elements 591 and 521 then connected.

In addition, the interface of the docking elements 591 and 521 then connected may advantageously have a unit for contactless transmission of signals. This unit for contactless signal transmission may be configured, for example, as a transmitter/receiver coil or as an inductive coupler with I/O link for contactless transmission of the signals. In addition or as an alternative, optical signal transmission is conceivable.

Here, the unit may be provided at any point at the interface of the docking elements 591 and 521 then connected or also outside the interface of the docking elements 591 and 521 then connected, with the unit for contactless signal transmission being advantageously provided centrally/in the middle of the interface of the docking elements 591 and 521 then connected.

For example, the docking section 523 of the unloading and loading device 520 on the driverless transport vehicle 510 comprises further docking elements 522 (configured as clamping cones, for example), which are configured to be connected to or docked with corresponding docking elements 592 of the docking section 590 during docking.

This advantageously results in precise positioning of the driverless vehicle 510 in the docked state or in the state of docking with the docking section 590 in which the driverless transport vehicle 510 is positioned in a predefined loading position.

In exemplary embodiments, the docking elements 522 may, for example, be fixed to or locked with the respective docking elements 592 so that a mechanical locking of the docked docking sections can be provided.

For this purpose, for example, cone-shaped sections may be provided as docking elements 522 or 592 for aligning and preferably also fixing the corresponding unloading and loading device 520 on the driverless transport vehicle 510 with respect to the supply unit 400. For such an alignment and simultaneous fixation, clamping cones, as are already known, for example, from the receptacle for pallets in a machine tool, may advantageously be used in exemplary embodiments.

The docking elements 522 and/or 592 may also include one or more interfaces for transmission of mechanical energy (for example a driven rotation of a coupling element on the corresponding docking element) and/or electrical, hydraulic and/or pneumatic energy.

The transmission of electrical energy may also be used to charge the battery or batteries of the driverless transport vehicle 510, for example. Furthermore, for example, operating means such as cooling lubricant could also be supplied. Appropriate fastening means and connections conducting electricity and/or fluids (fastening means and connections) may be provided for this purpose, for example.

FIG. 1B shows the driverless transport vehicle 510 in the docked state at the loading position by way of example. In this case, the docking section 523 of the driverless transport vehicle 510, which is still clearly visible in FIG. 1A, is docked to the docking section 590 at the loading position.

The loading bar 410 is moved downwards in FIG. 1B by means of the lifting unit 420, for example, and, in this state, is positioned at a level lower than the height of the tool retaining section 530 of the driverless transport vehicle 510. Due to the precise positioning of the driverless transport vehicle 510 in the docked state, the row of retaining sections of the tool retaining section 530 lies exactly above the row of receiving sections 411 of the loading bar 410.

In particular, the tool retaining section 530 in FIGS. 1A and 1B comprises only four retaining sections by way of example. By way of example (without restriction to exactly four), the number of retaining sections of the tool retaining section 530 is therefore the same as the number of tool receptacles 411 of the loading bar 410 and, in addition, the retaining sections of the tool retaining section 530 are arranged in a row adjacent to one another, at the same distance as the distance between tool receptacles 411 of the loading bar 410.

In exemplary embodiments, the number of retaining sections of the tool retaining section 530 is preferably less than or equal to the number of tool receptacles 411 of the loading bar 410; the number of tool receptacles 411 of the loading bar 410 is particularly preferably an integral multiple of the number of retaining sections of the tool retaining section 530.

According to FIG. 1B, the loading bar 410 may now be lifted by the lifting unit 420 until the tools WZ or tool interfaces held on the retaining sections of the tool retaining section 530 are received or inserted in the tool receptacles 411 of the loading bar 410.

Then the docked state may be exited and the driverless transport vehicle 510 may move backwards away from the loading position so that the tools or tool interfaces can be released from the retaining sections of the tool retaining section 530 and the loading bar 410 can be lifted to the handover position. This concludes an exemplary fully automated loading process.

Furthermore, an unloading process may be carried out the loading bar 410 loaded with tools being moved into the loading position and the transport vehicle 510 approaching the docking section 590 and docking, with the retaining sections of the tool retaining section 530 being moved up to the tools WZ and engaging in gripper grooves of the tool interfaces of the tools held by the loading bar 410 when the transport vehicle 510 is docked. The loading bar 410 may then be moved downwards, with the receptacles 411 of the loading bar 410 releasing the tools retained on the retaining sections of the tool retaining section 530.

The docked state may then be exited and the driverless transport vehicle 510 may move backwards away from the loading position, with the tools or tool interfaces being retained on the retaining sections of the tool retaining section 530. This completes an exemplary fully automated unloading process.

The movement of the loading bar 410 at the loading position may be synchronized with the docking process by detecting the docking state via a data interface, the connected I/O link and/or via the locking of the docking elements by means of the machine control of the machine tool or a control unit of the supply unit. In addition, the approach of the vehicle 510 may be monitored via motion sensors and/or via a contactless communication link.

This results in fully automated loading and unloading of tools (or workpieces or components) on the machine tool. It should be noted that an analogous docking station may be provided in a storage area so that the unloading or loading device 500 or the driverless transport vehicle 510 may be loaded partially or fully automatically at the docking station (similarly to the docking station including the docking section 590 and a possible supply unit on a storage magazine) for the subsequent partially or fully automated loading of a machine tool.

The vehicle 510 preferably travels fully automatically between loading positions on machine tools and loading positions or docking stations on tool and/or component stores.

In further embodiments, however, it is possible to provide a simplified configuration in which the vehicle 510 is controlled or steered manually, but is possibly powered or has drive and/or steering assistance; see FIG. 3.

FIG. 3 shows an exemplary perspective illustration of a further exemplary embodiment of a supply trolley or transport vehicle 510 of an unloading or loading device 500 according to an exemplary embodiment of the invention.

The transport vehicle 510 in FIG. 3 includes, similarly to the driverless transport vehicle 510 in FIG. 1A, an unloading and loading device 520 (e.g. a removable unloading and loading module) on the top of the vehicle, for example with a docking section 523 pointing forward (i.e., in the main direction of travel, for example, or, in other exemplary embodiments, pointing transversely to the main direction of travel) including exemplary docking elements 521 and 522 and a tool retaining section 530 on which, for example, a row or plurality of tools WZ or tool interfaces holding tools WZ are retained. This is analogous to the above description of FIGS. 1A and 1B.

In contrast to the embodiment of FIGS. 1A and 1B, however, the transport vehicle 510 in FIG. 3 is equipped with a handle section G by means of which an operator B can grip the vehicle and push and/or steer it, potentially with drive assistance.

The transport vehicle 510 in FIG. 3 is configured to drive up to the docking section 590 or to be driven up thereto by the operator and to dock with the docking section 523 of the unloading and loading device 520 according to FIG. 1A.

For example, the docking section 523 of the unloading and loading device 520 on the transport vehicle 510 in turn comprises further docking elements 521 (configured as clamping cones, for example), which may be configured to be connected to or dock with corresponding docking elements 592 of the docking section 590m during docking. This in turn advantageously results in precise positioning of the driverless vehicle 510 in the docked state or in the state docked to the docking section 590, in which the driverless transport vehicle 510 is positioned in a predefined loading position.

In the docked state analogous to FIG. 1B, the loading bar 410 may be lifted by the lifting unit 420 until the tools WZ or tool interfaces retained on the retaining sections of the tool retaining section 530 are received or inserted in the tool receptacles 411 of the loading bar 410. Then, the docked state may be exited and the transport vehicle 510 may be driven backwards away from the loading position by the operator B so that the tools or tool interfaces can be released from the retaining sections of the tool retaining section 530 and the loading bar 410 can be lifted to the handover position. This concludes an exemplary partially automated loading process.

Furthermore, an unloading process may be carried out the loading bar 410 loaded with tools being moved into the loading position and the transport vehicle 510 being driven up to the docking section 590 by the operator B and docking, the retaining sections of the tool retaining section 530 being brought up to the tools WZ and engaging in gripper grooves of the tool interfaces of the tools held on the loading bar 410 when the transport vehicle 510 is docked.

The loading bar 410 may then be moved downwards, with the receptacles 411 of the loading bar 410 releasing the tools held on the retaining sections of the tool retaining section 530. The docked state may then be exited and the transport vehicle 510 may be driven backwards away from the loading position by the operator B, with the tools or tool interfaces being retained on the retaining sections of the tool retaining section 530. This completes an exemplary partially unloading process.

The movement of the loading bar 410 at the loading position may be synchronized with the docking process by detecting the docking state via a data interface, the connected I/O link and/or via the locking of the docking elements by means of the machine control of the machine tool or a control unit of the supply unit. In addition, the approach of the vehicle 510 may be monitored via motion sensors and/or via a contactless communication link.

This results in a partially automated loading or unloading of tools (or workpieces or components) on the machine tool. It should be noted that an analogous docking station may be provided in a storage area so that the unloading or loading device 500 or the transport vehicle 510 guided by the operator B may be loaded partially or fully automatically at the docking station (analogous to the docking station including the docking section 590 and a possible supply unit at a storage magazine) for the subsequent partially or fully automated loading of a machine tool.

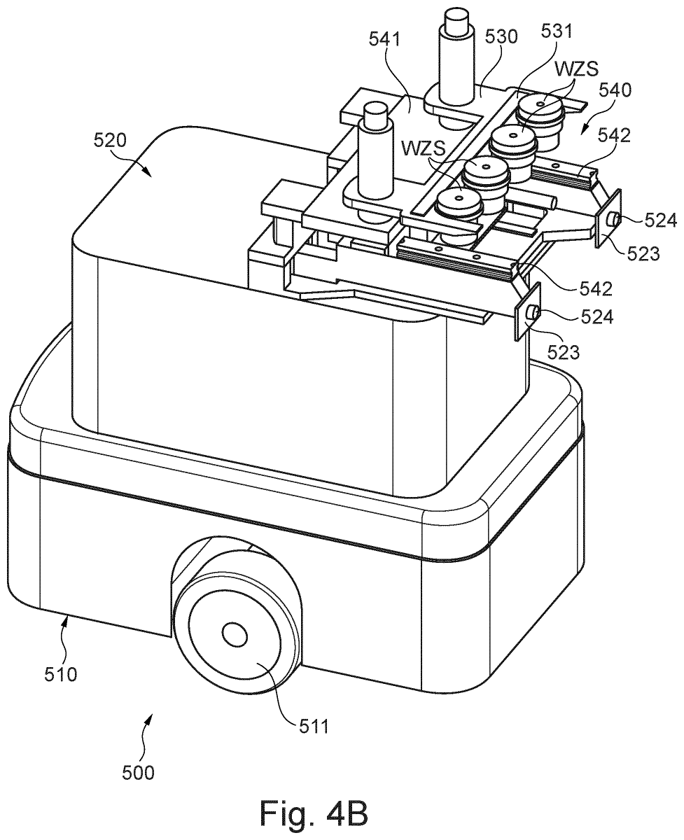

FIGS. 4A and 4B show exemplary perspective illustrations of a further exemplary embodiment of a supply trolley or transport vehicle 510 of an unloading or loading device 500 according to an exemplary embodiment of the invention.

Similarly to the embodiment according to FIGS. 1A and 1B, the transport vehicle is configured as a driverless transport vehicle 510, for example. In the underframe and the interior, the driverless transport vehicle 510 may be configured similarly to the driverless transport vehicle 510 according to FIGS. 1A and 1B so that all of the above descriptions of driverless transport vehicles can be applied.

The driverless transport vehicle 510 according to FIGS. 4A and 4B, however, differs in the configuration of the unloading or loading device 520 arranged on the driverless transport vehicle 510.

The driverless transport vehicle 510 according to FIGS. 4A and 4B comprises an unloading or loading device 520 on which a tool retaining section 530 with retaining sections which can retain the respective tools or tool interfaces is again provided at the top on the front or end side. In FIGS. 4A and 4B, only tool interfaces WZS without tools are shown by way of example, which, however, can hold respective tools similarly to FIG. 1A.

For example, the unloading or loading device 520 includes a handover unit 540 with linear guides 542 on which a carriage 541 is arranged such that it can be moved linearly. The carriage 541 carries, for example, the tool retaining section 530 with the retaining sections retaining, for example, tool interfaces WZS. This has the advantage that the tool retaining section 530 can be moved toward the loading bar in the docked state of the driverless transport vehicle 510 at the loading position of the loading bar 410.

For the docking state, the unloading or loading device 520 includes docking sections 523 with respective docking elements 524. This enables partially or fully automated loading or unloading processes in which the displacement of the tool retaining section 530 relative to the loading bar 410 for removing or inserting the tools can be advantageously carried out (which is done by moving the transport vehicle in FIGS. 1A and 1C) when the driverless transport vehicle 510 is in the docked state (docking state) and therefore precisely positioned. This increases the precision and efficiency of the loading and unloading operations.

In addition, the docking sections 523 with respective docking elements 524 may dock directly with docking elements 593, which may be attached directly to the loading bar 410 (see, e.g., FIG. 2), wherein, for example, locking of the docking elements 524 and 593 may not be intended. The docking is then realized by the unlocked contact of the docking elements 524 and 593.

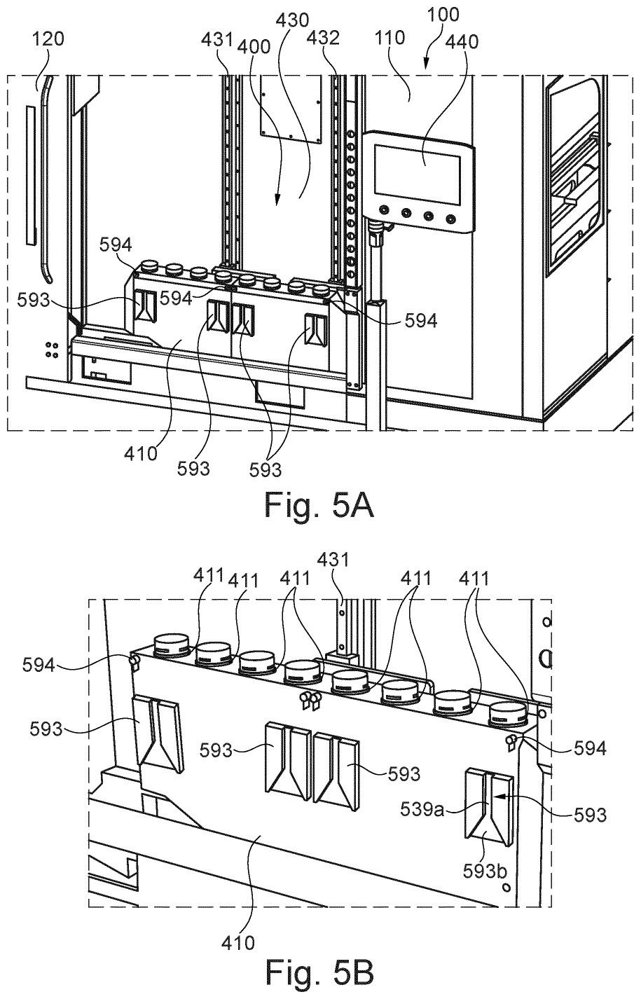

FIGS. 5A and 5B show exemplary detailed perspective illustrations of a tool bar (loading bar) of the supply unit of the tool magazine of the machine tool according to an embodiment of the invention.

The loading bar 410 is configured similarly to FIG. 2 and may be lifted and rotated along guides 431 and 432 by means of a lifting unit 420 similarly to the description of FIGS. 1A to 2 from the loading position shown in FIG. 5A to the handover position.

As an example, a machine housing 110 of machine tool 100 is shown in FIG. 5A, in which supply unit 400, tool magazine 200, tool changing device 300, work spindle and work space may be arranged. In addition, an automatically controllable sliding door 120 (exemplarily in the open state) is shown which can be closed automatically in order to seal off the loading position of the supply unit 400 or the loading bar 410 from the outside when no unloading or loading process is being carried out.

An operating device 440 of the supply unit 400 is arranged, for example, to the side of the loading position on the machine housing wall. Here, an operator may control the supply unit 400, for example via a touchscreen on the operating device 440 or, in other exemplary embodiments, via operating units such as buttons, rotary controls, keyboards or other input devices, in particular for operation during an unloading and/or loading process, for example.

This may include one or more operable functions or operating functions, such as: automatically opening and/or closing the door 120, automatically moving the loading bar 410, e.g. to the loading position and/or to the handover position, moving the loading bar 410 in an operator-controlled manner, including operator-controlled alignment of the loading bar 410, operator-controlled vertical movement of the loading bar 410 and/or operator-controlled rotation of the loading bar 410, locking and/or unlocking all or individual tools or tool interface receptacles 411 of the loading bar 410 at the loading position, selecting tools and/or workpieces to be unloaded from the magazine 200, and other operating functions.

In addition, if necessary, further tool data for tools and/or workpieces/components to be loaded may be entered by the operator or transmitted via a data interface (e.g. via data interfaces using Bluetooth, WLAN, RFID, USB, etc.). Information about the tools or workpieces to be unloaded may also be displayed to the operator via the monitor or the touchscreen or data about the tools and/or workpieces to be unloaded may be output via such data interfaces.

As already shown by way of example in FIG. 2, the loading bar 410 includes docking elements 593 arranged on the outside; see FIG. 5A and also, in detail, FIG. 5B.

In addition, the loading bar 410 includes positioning elements 594, which will be explained by way of example below in conjunction with the docking of a transport vehicle 510 according to FIGS. 4A and 4B, at the level of the tool receptacles.

Exemplary (optional) detail features according to exemplary embodiments are discussed below.

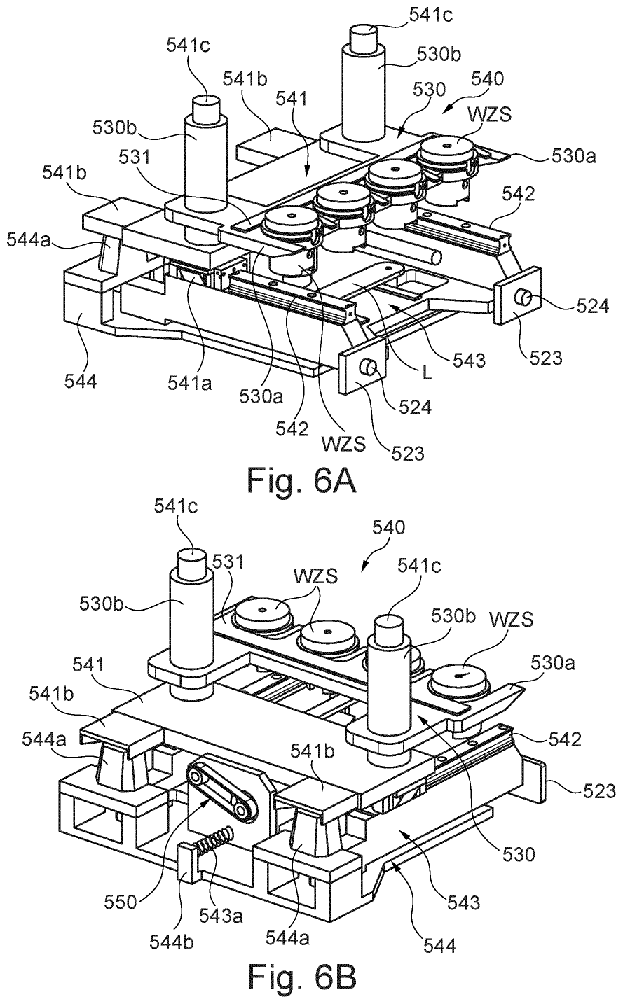

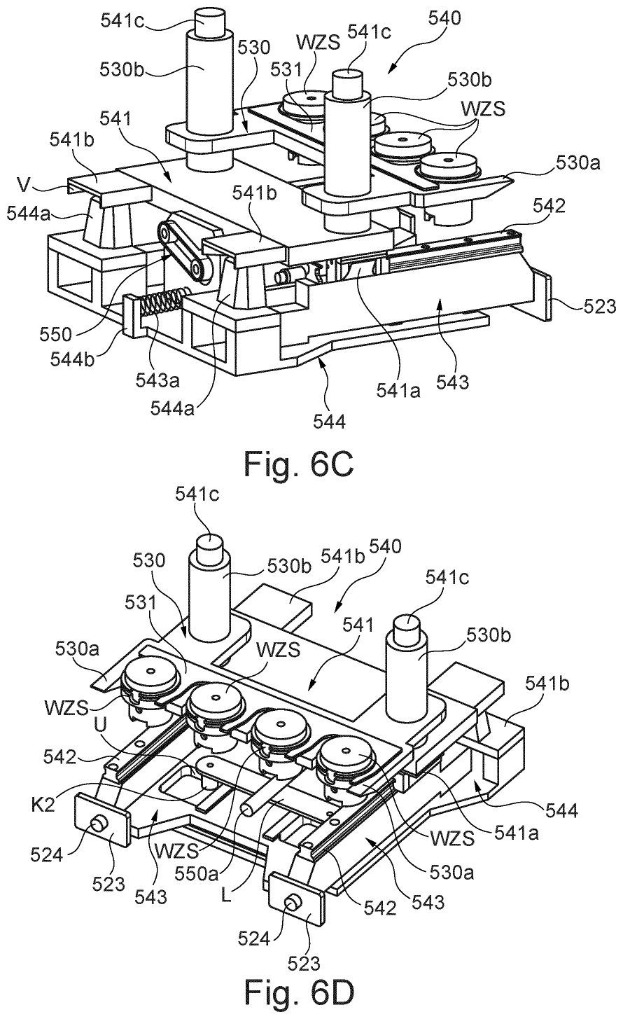

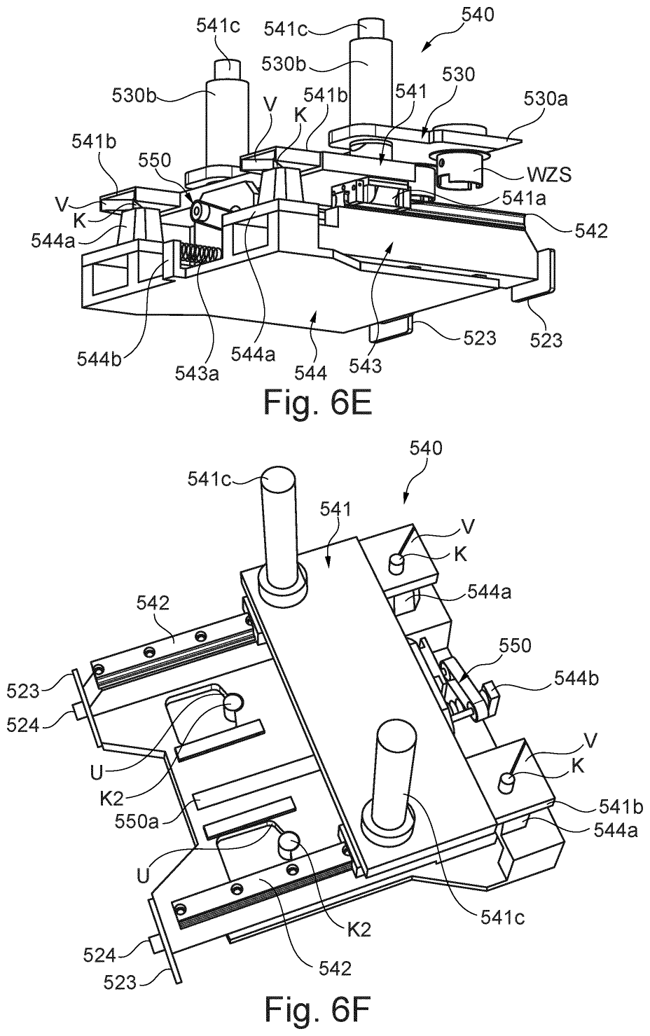

FIGS. 6A to 6F show exemplary perspective illustrations of a supply unit or handover unit 540 of a supply trolley or transport vehicle 510 of an unloading or loading device according to FIGS. 4A and 4B.

The handover unit 540 includes, for example, linear guides 542 on which a linearly displaceable carriage 541 is arranged so as to be linearly displaceable. The carriage 541 carries, for example, the tool retaining section 530 with the retaining sections retaining, for example, tool interfaces WZS. This has the advantage that the tool retaining section 530 can be moved toward the loading bar in the docked state of the driverless transport vehicle 510 at the loading position of the loading bar 410.

For the docking state, the unloading or loading device 520 includes docking sections 523 with respective docking elements 524. This enables partially or fully automated loading or unloading processes in which the displacement of the tool retaining section 530 relative to the loading bar 410 for removing or inserting the tools can be carried out (which is done by moving the transport vehicle in FIGS. 1A and 1C) when the driverless transport vehicle 510 is in the docked state (docking state) and therefore precisely positioned. This increases the precision and efficiency of the loading and unloading operations.

In addition, the docking sections 523 with respective docking elements 524 may dock directly with docking elements 593, which may be attached directly to the loading bar 410 (see, e.g., FIGS. 2, 5A and 5B), wherein, for example, locking of the docking elements 524 and 593 may not be intended. The docking is then realized by the unlocked contact of the docking elements 524 and 593.

For example, the front section of the tool retaining section 530 is rake-shaped, wherein a tool interface is or can be held (preferably with the tool pointing upwards) between pairs of adjacent tine sections, in particular, for example, at their gripper groove. This may also be referred to as a gripper bar, for example, since a bar having a series of tool gripper sections (i.e., the gripper sections formed between tine sections of the rake-shaped section for receiving one tool interface each, particularly at the gripper groove thereof).

The rake-shaped configuration allows for simple formation of a horizontally arranged row of retaining sections for respectively receiving a tool or the tool interface holding the tool. By way of example, the tool retaining section 530 in FIGS. 6A to 6F includes four retaining positions or four retaining sections (five tine sections with four holding gaps between the tine sections). In other exemplary embodiments, however, more or fewer retaining sections may also be formed.

An optional locking element 531, which is also formed in the shape of a rake and is also held, for example, in the transverse direction of the transport vehicle 510, i.e. in particular in the direction of the row of retaining sections of the tool retaining section 530, is arranged on the tool retaining section 530, for example. The rake-shaped locking element 531 extends, in particular, in parallel to the rake-shaped section of the tool retaining section 530.

By moving the locking element 531 in the direction of the row of retaining sections of the tool retaining section 530, the gaps in the rake-shaped locking element 531 can be shifted to more or less overlap with the gaps in the rake-shaped section of the tool retaining section 530 in order to lock or unlock the tools or tool interfaces WZS retained. This may preferably be provided by a spring-biased or electromagnetic biasing mechanism and/or controlled automatically, e.g. via electromagnetic, electronic, pneumatic and/or hydraulic actuators.

For example, the outer tine sections 530a of the tool retaining section 530 are configured to be tapered towards the front, with the underside of the outer tine sections 530a extending obliquely, for example.

This is an optional or exemplary configuration for precise height positioning when docking with the loading bar 410, in that, when the tool retaining section 530 is moved forwards or toward the loading bar 410 at the loading position, the outer tine sections 530a can interact with the oblique underside on the positioning elements 594 (see FIGS. 5A and 5B), preferably in an unloading process in which an empty tool retaining section 530 is moved up to the loading bar 410.

For example, for this purpose, the positioning elements 594 may include rollers or roller elements which roll on the oblique underside of the outer tine sections 530a and push or guide the tool retaining section 530 upwards when the tool retaining section 530 is moved forwards or towards the loading bar 410 at the loading position, in particular for exact height alignment with gripper grooves at tool interfaces to be unloaded on the receptacles 411 of the loading bar 410 at the loading position.

The tool retaining section 530 also includes, for example, vertically oriented guide sections 530b configured, for example, in the form of a hollow cylinder and held in a vertically displaceable manner on vertical guides 541c of the carriage 541 which are configured in the form of a cylinder. This makes the exemplary height alignment of the tool retaining section 530 possible in a particularly simple and compact manner.

By way of example, two guide sections 530b or two vertical guides 541c are provided which are arranged next to one another, for example, in the transverse direction or in the direction parallel to the row of retaining sections of the tool retaining section 530. This stabilizes the horizontal alignment of the tool retaining section 530 with respect to the horizontally aligned longitudinal direction of the loading bar 410 at the loading position or the row of tool receptacles thereof.

In further exemplary embodiments, further guide sections 530b or vertical guides 541c may be provided, in particular for further stabilization of the horizontal alignment of the tool retaining section 530 in the horizontal plane.

The carriage 541 of the handover unit 540 carries, for example, the tool retaining section 530, in particular optionally in a height-adjustable manner by means of the vertical guides 541c. The carriage 541 itself is guided in a linearly displaceable manner with the guide elements 541a on linear guides 542 arranged on a first carrier section 543 (upper carrier plate).

The linear guides 542 are oriented horizontally, for example, and extend forward (i.e. in particular in the main direction of travel of the transport vehicle 510) or perpendicular to the row of retaining sections of the tool retaining section 530.

The carriage 541 can be moved forwards (i.e. towards the loading bar 410 in the docked state) and backwards (i.e. away from the loading bar 410 in the docked state) on the linear guides 542. This is drive-controlled, for example, and can be driven, for example, by means of the drive 550 held on the first carrier section 543 (as an example shown by a toothed belt transmission) and a drive shaft 550a driven by the drive 550 (e.g. via a screw or ball screw drive).

By moving the carriage 541 on the linear guides 542, the tool retaining section 530 held on the carriage 541 in the docked state can be moved horizontally towards (forwards with respect to the main direction of travel of the transport vehicle 510) or away from (backwards with respect to the main direction of travel of the transport vehicle 510) of the loading bar 410.

The first carrier section 543 carrying the drive 550 and including the guides 542 is held on a second carrier section 544 (lower carrier plate). For example, the first carrier section 543 is held or mounted in a floating manner on the second carrier section 544, with the floating mounting particularly preferably allowing for a movement of the first carrier section 543 in the horizontal plane (i.e. in both orthogonal horizontal directions) or at least horizontally in the direction of the main direction of travel of the transport vehicle 510 or the direction of travel of the carriage 541.

For example, the first carrier section 543 is biased forward (i.e. towards the loading bar 410 in the docked state) by means of a spring held on a fastening section 544b of the second carrier section 544. In addition to spring mechanisms such as one or more spring elements, other, e.g. mechanical-elastic and/or electromagnetic, force-exerting biasing mechanisms are also possible in other exemplary embodiments.

On the rear side (i.e. in particular, for example, the side facing away from the tool retaining section 530 or the loading bar 410 in the docking state) of the carriage 541, stopper sections 541b are arranged, for example, or, in this exemplary embodiment, attached to the carriage 541 as stopper elements.

The stopper sections 541b can be brought into engagement or contact with stopper sections 544a which are arranged on the rear side (i.e., in particular, for example, the side facing away from the tool retaining section 530 or the loading bar 410 in the docking state) on the second (lower) carrier section 544 or, in this exemplary embodiment, for example, are attached to the second (lower) carrier section 544 as stopper elements, for example on the upper side of the second (lower) carrier section 544.

In the state in which the carriage 541 has been moved completely backwards (i.e. in the direction of the side facing away from the tool retaining section 530 or, in the docking state, the loading strip 410), the handover unit 540 is, for example, in a locked state or blocked state (self-centered and locked transport state), which is achieved by two form-fitting locking mechanisms as an example. This secures the device for transport, i.e. for driving operation of the transport vehicle 510, e.g. to or from the machine tool, between different machine tools or between the machine tool and a tool or workpiece supply station.

In FIGS. 6A to 6F, the handover unit 540 is shown in the locked state (self-centered and locked transport state) by way of example. Here, the carriage is moved to the rear position and the stopper sections 541b on the carriage 541 are brought into engagement or (in particular, for example, form-fitting) contact with the stopper sections 544a on the second (lower) carrier section 544.

See FIGS. 6E and 6F, in particular, in which it is apparent that button-shaped form-fitting elements K optionally attached or arranged on the stopper sections 544a engage in, for example, substantially V-shaped form-fitting sections V on the underside of the stopper sections 541b of the carriage 541 and abut form-fittingly at the tapered end the essentially V-shaped form-fitting sections V. Thus, further movement of the carriage 541 to the rear is blocked in a form-fitting manner, for example.

In addition, horizontal transverse movement (i.e. perpendicular to the guides 542) is form-fittingly blocked at this position by the tapered end of the substantially V-shaped form-fitting sections V. In this position, only a driven movement of the carriage 541 forward is possible and all other directions of movement in the horizontal plane (to the rear and to the sides) are blocked, in particular also movements of the first (upper) carrier section 543, which while optionally being mounted on the second (lower) carrier section in a floating manner, is carrying the carriage 541 blocked form-fittingly.

In the rear position of the carriage 541, the form-fitting elements K of the stopper sections 544a engage in the essentially V-shaped form-fitting sections V on the underside of the stopper sections 541b of the carriage 541, for example, and abut at the tapered end of the substantially V-shaped form-fitting sections V in a form-fitting manner and form a form-fitting stop, for example.

Movement of the first (upper) carrier section 543 horizontally forward or away from the stopper sections 544a is blocked by a second exemplary form-fitting locking mechanism.

For this purpose, button-shaped form-fitting elements K2 are attached or formed on the upper side of the second (lower) carrier section 544 (see e.g. FIGS. 6D and 6F), said button-shaped form-fitting elements K2 engaging in openings U of the first (upper) carrier section 543 and abutting at the rear side of the openings U in the locked or blocked state, in particular, for example, due to the bias of the spring 543a which exerts a forward biasing force on the first (upper) carrier section 543.

The form-fitting connection of the form-fitting elements K2 of the second (lower) carrier section 544 on the rear side of the openings U of the first (upper) carrier section 543, which tapers towards the rear, is configured, for example, in such a way that the movement of the first (upper) carrier section 543, which may optionally be mounted in a horizontally floating manner on the second (lower) carrier section 544, is form-fittingly blocked relative to the second (lower) carrier section 544.

In particular, in the locked state or blocked state of the handover unit 540, the horizontal forward movement (i.e., in the direction of the biasing force of the spring 543a) of the first (upper) carrier section 543 on the second (lower) carrier section 544 is blocked in a form-fitting manner by the contact of the form-fitting elements K2 of the second (lower) carrier section 544 at the rear side of the openings U of the first (upper) carrier section 543.

In addition, a (horizontal) lateral movement (i.e. in the transverse direction) of the first (upper) carrier section 543 on the second (lower) carrier section 544 is blocked in a form-fitting manner as a result of the contact of the form-fitting elements K2 of the second (lower) carrier section 544 at the rear side of the openings U of the first (upper) carrier section 543.

In the locked state or blocked state of the handover unit 540 according to FIGS. 6A to 6F, the carriage 541 with the tool receiving section 530 is moved completely backwards or to the side facing away from the docking sections 523 and is locked in this position or the mobility in one or more horizontal directions or in particular in the horizontal plane is blocked.

Here, the locked state is optionally and only by way of example achieved or realized by means of form-fitting locks or form-fitting stops, in particular due to the first form-fitting lock or the form-fitting stop of the form-fitting elements K in the stopper sections 544a and 541b and the second form-fitting lock or the form-fitting stop of the form-fitting elements K2 of the second (lower) carrier section 544 on the rear sides of the openings U of the first (upper) carrier section 543.

This is an exemplary embodiment for optionally providing a secure, locked and retracted transport position of the tool receiving section 530 on the transport vehicle 510 (self-centered and locked transport state).

In addition, the centering contours on the stopper sections (particularly sections V and/or U) in this exemplary embodiment have the further advantage that the retraction of the handover unit to the locked transport position (blocked state or locked state or self-centered and locked transport state) not only secures the transport, but also centers the handover unit 540 itself or brings it into a self-centered state each time it is retracted into the locked transport position. In this way, it can advantageously be avoided that alignment processes could cumulatively lead to an excessively large centering error when docking at supply units.

To further secure the optional blocked state or locked state of the entire structure or to provide the horizontally floating mounting of the first (upper) carrier section 543 on the second (lower) carrier section 544, according to this exemplary embodiment, there is also an optional fastening bar L at the upper ends of the form-fitting elements K2 of the second (lower) carrier section 544, see, e.g., FIGS. 6A and 6D.

For loading and unloading processes, the blocked or locked state must be released, in particular as described below by way of example.

The release of the locked state or blocked state can be carried out by driven movement of the carriage 541 forward or away from the stopper sections 544a or towards the docking sections 523. The carriage 541 or the tool receiving section 530 may be released from the first lock (for example the first form-fitting lock or form-fitting stop of the form-fitting elements K in the stopper sections 544a and 541b) by moving the carriage 541 forward in a driven manner.

When the transport vehicle 510 is now moved forwards until the front or end-side docking sections 523 come into contact with an obstacle (e.g. during the docking process of the docking sections 523 at the docking elements 593 of the loading bar 410 in the loading position) and thus exert a force on the docking sections 523 attached or arranged at the first (upper) carrier section 543 to the rear or towards the side facing away from the tool retaining section 530, the first (upper) carrier section 543 may be pressed relative to the second (lower) carrier section 544 against the biasing force of the spring 544b so that the second lock (for example the second form-fitting lock or the form-fitting stop of the form-fitting elements K2 of the second (lower) carrier section 544 on the rear sides of the openings U of the first (upper) carrier section 543) may be released.

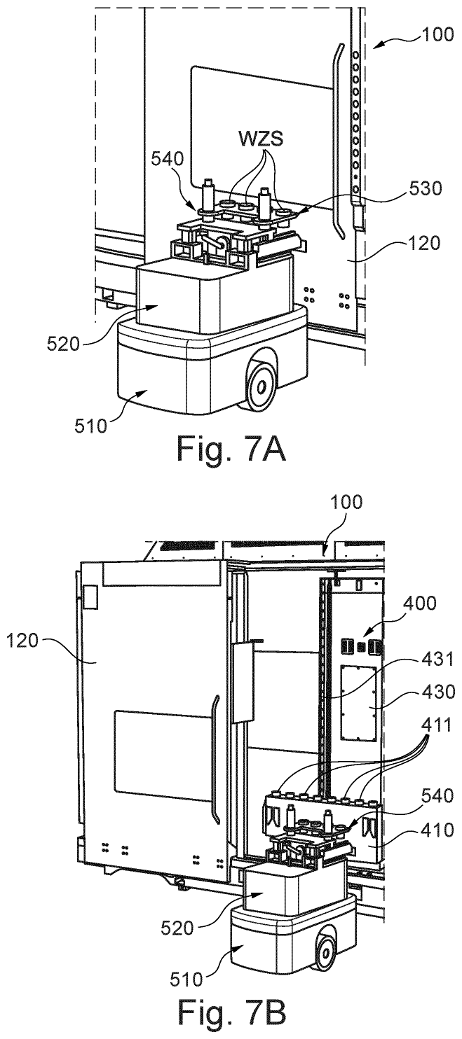

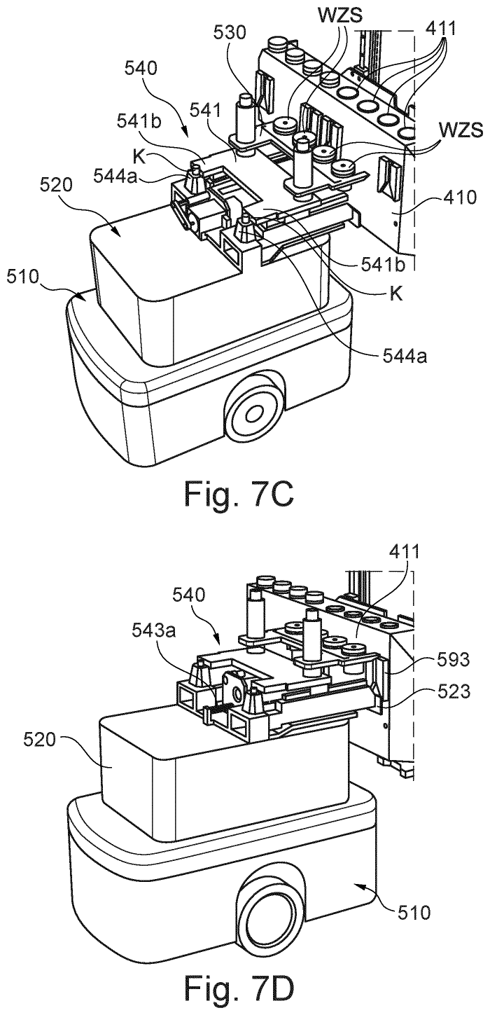

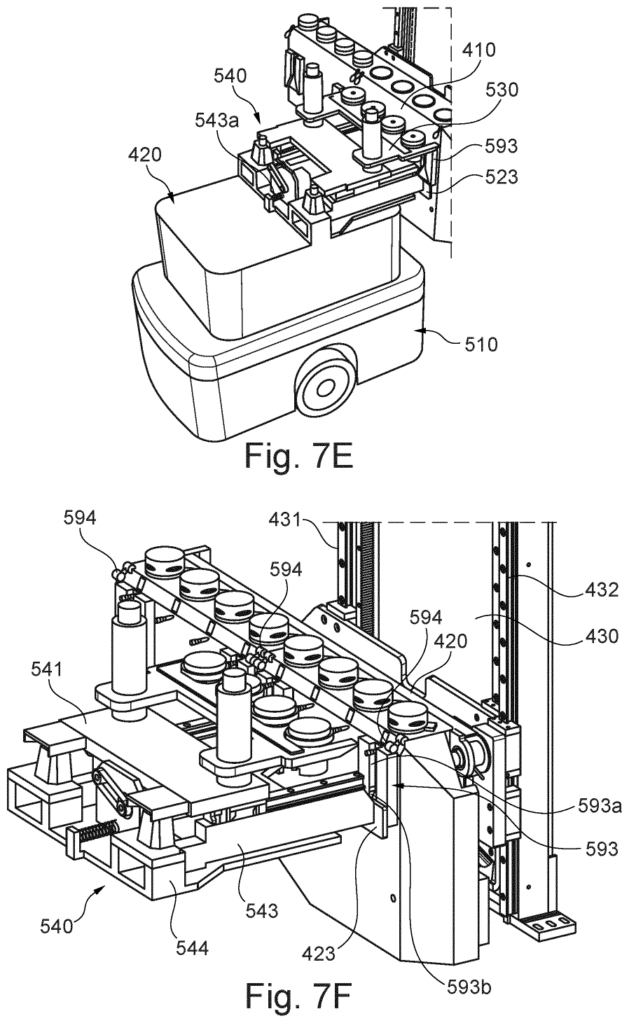

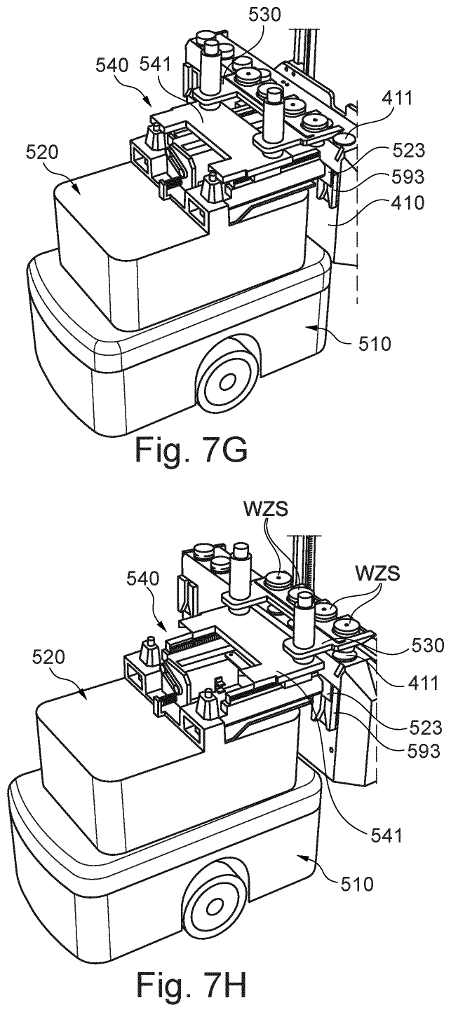

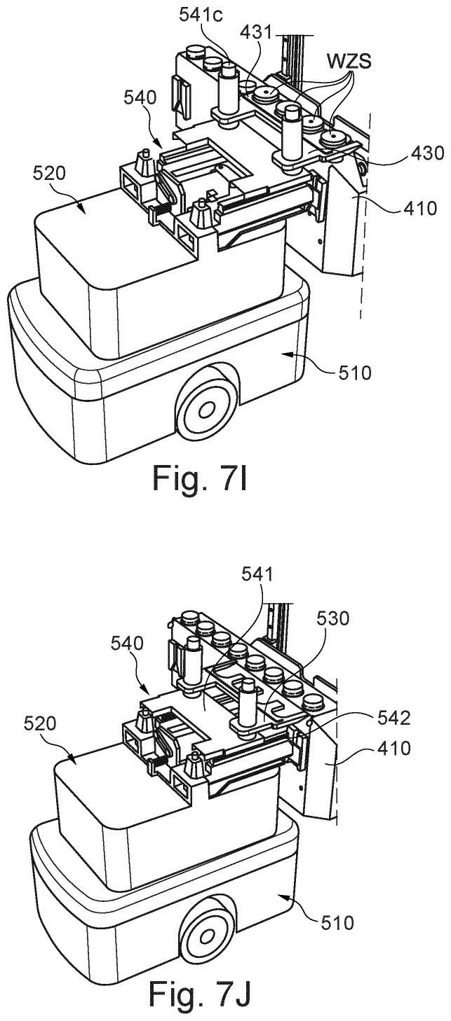

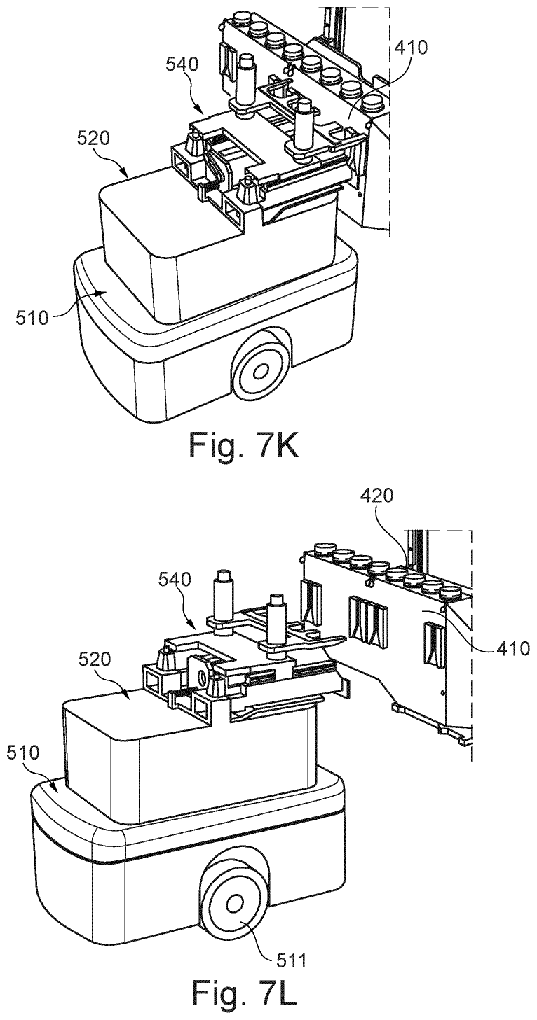

FIGS. 7A to 7L show exemplary perspective illustrations of the supply trolley or transport vehicle according to FIGS. 4A and 4B to illustrate an exemplary loading process, in particular as an example with a handover unit 540 according to FIGS. 6A to 6F.

In FIG. 7A, the driverless transport vehicle 510 approaches the door 120 on the side of machine tool 100, for example. As an example, four tool interfaces WZS, which are to be unloaded on the machine tool 100 or with which the machine tool 100 is to be loaded, are retained on the tool retaining section 530 of the handover unit 540 of the unloading and loading device 520 arranged on the vehicle 520.

The (optional) door 120 can be opened and, when the door 120 is open, the loading position of the supply unit or the loading bar 410 arranged at the loading position of the supply unit 400 is accessible; see FIG. 7B.

In addition, for example, the first lock of the tool retaining section 530 is released or the carriage 541 of the handover unit 540 is moved forward or towards the loading bar 541; see, e.g., FIG. 7C. Here, the form-fitting elements K on the stopper sections 544a are released, for example, from engagement or contact with the stopper sections 541b of the carriage 541.

In addition, FIG. 7C shows by way of example that the four right-hand tool receptacles 411 of the horizontally oriented loading bar 410 located at the loading position are empty, with the four tool interfaces WZS retained on the tool retaining section 530 of the handover unit 540 being placed or inserted on these tool receptacles 411 so that they can then be loaded on the tool magazine 200 by means of the supply unit 400.

The transport vehicle 510 may now be moved into the docking state my docking the docking elements 524 arranged on the front or end-side docking sections 523 with the docking elements 593 on the front or end-side of the loading bar 410 or bringing them into contact therewith; see e.g. FIGS. 7D and 7E.

On the one hand, the docking elements 524 dock with the docking elements 593 on the front or end side of the loading strip 410 and, on the other hand, the second lock may be released as a result (e.g. by compressing the spring 543a, cf. FIG. 7D with 7E, the spring being compressed in FIG. 7E by way of example).

Here, the docking process is illustrated in more detail in the detailed representation of FIG. 7F by way of example. The loading bar 410 is moved slightly upwards by the lifting unit 420 of the supply unit so that the docking sections 423 with their docking elements 424 (see FIG. 6A) dock, or are brought into contact with, the lower side of the docking elements 593.

For example, a front or end-side contour section 593a, which is configured as a vertically extending guide channel opened to the front, for example, is formed with a lower guide section 593b that tapers upwards toward the contour section on the docking elements 593 (see FIG. 5B). First, the docking sections 423 come into contact, with docking elements 424 thereof, with the guide section 593b of the docking elements 593, which tapers upwards towards the contour section 593a. On the one hand, this aligns the handover unit 540 with the loading bar 410 in terms of depth and, on the other hand, the contact of the plurality of pairs of docking elements 524 and 593 corresponding to one another corrects any angular error or aligns the handover unit 540 at an exact angle with respect to the loading bar 410.

The loading bar 410 may then be moved downwards so that the docking elements 424 of the docking sections 423 are guided in the guide section 593b of the docking elements 593, which tapering upwardly, into the contour section 593a of the docking elements 593. This also achieves, for example, a lateral position alignment of the tool retaining section 430, particularly preferably by means of the optional laterally horizontally floating mounting of the first (upper) carrier section 443 on the second (lower) carrier section 544 then unlocked.

FIG. 7G shows an example of the loading position of the loading bar 410 moved downwards, in which the docking elements 424 of the docking sections 423 are inserted and docked in the respective contour section 593a of the docking elements 593. The carriage 541 with the tool retaining section 530 may now be moved forward to the loading bar 410 so that the tool interfaces WZS retained on the tool retaining section 530 are positioned over the empty tool receptacles 411 of the loading bar 410; see FIG. 7H.

When the loading bar 410 is now moved upwards, the tool interfaces WZS retained on the tool retaining section 530 are inserted or received on the empty tool receptacles 411 of the loading bar 410 positioned underneath and, if necessary, unlocked via the locking element 431 on the tool retaining section 730; see FIG. 7I.

Here (particularly preferably before the unlocking), a height compensation or a height alignment may take place, e.g. by the loading bar 410 coming into contact with the underside of the tool retaining section 530 (or, for example, via the positioning elements 594 arranged on the front side) and, if necessary, by entraining the tool retaining section 530, which is held at the guide sections 541c such that it can be displaced vertically upwards or moved, by a remaining vertical movement of the loading bar 410.

This may be detected via a sensor system on the handover unit 540 and may trigger the unlocking of the locking element 431 via an automated control. In further exemplary embodiments, a mechanical biasing mechanism may be triggered by the movement of the tool retaining section 530 on the guide sections 541c in order to cause the unlocking of the locking element 431 mechanically.

After the tool interfaces WZS have been inserted or received on the previously empty tool receptacles 411 of the loading bar 410, the carriage 541 of the handover unit 540 with the tool retaining section 530 then empty may be moved backwards or away from the loading rail 410 at the loading position on the linear guides 542; see FIG. 7J.

For loading the tool magazine 200, the loading bar 410 may be lifted from the loading position by means of the supply unit 400 or its lifting unit 420, possibly to be moved to the handover position. The transport vehicle 510 may be driven backwards away from the loading bar 410 via the internal drive or by means of the driven wheels 511; see FIGS. 7K and 7L.

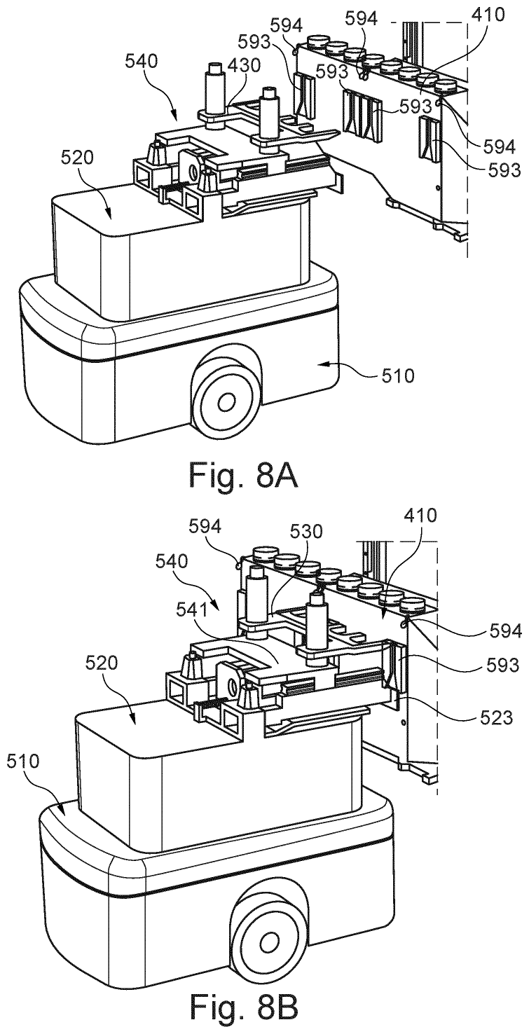

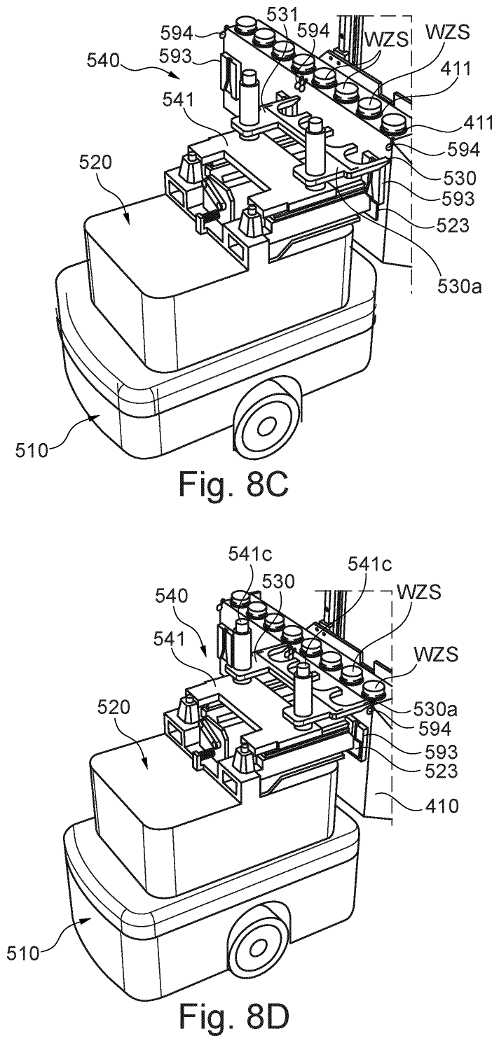

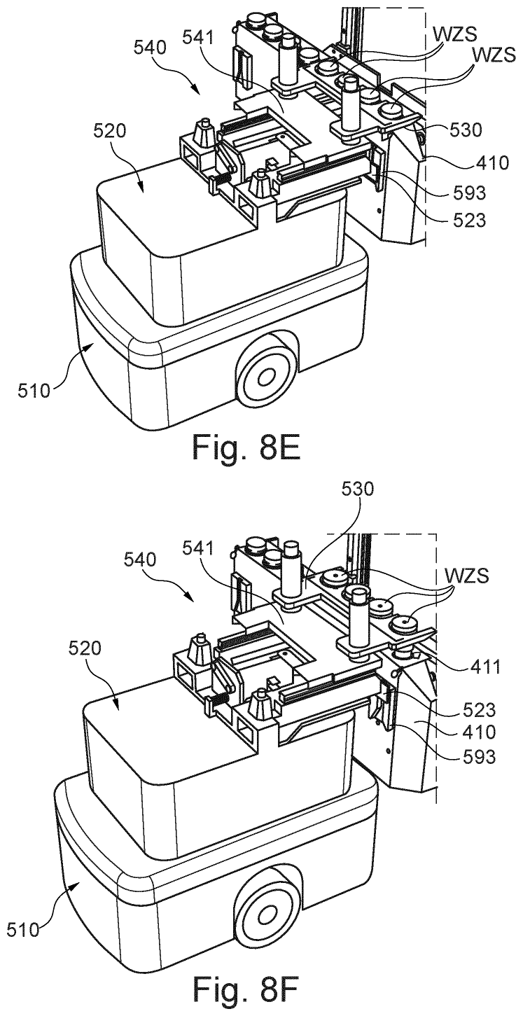

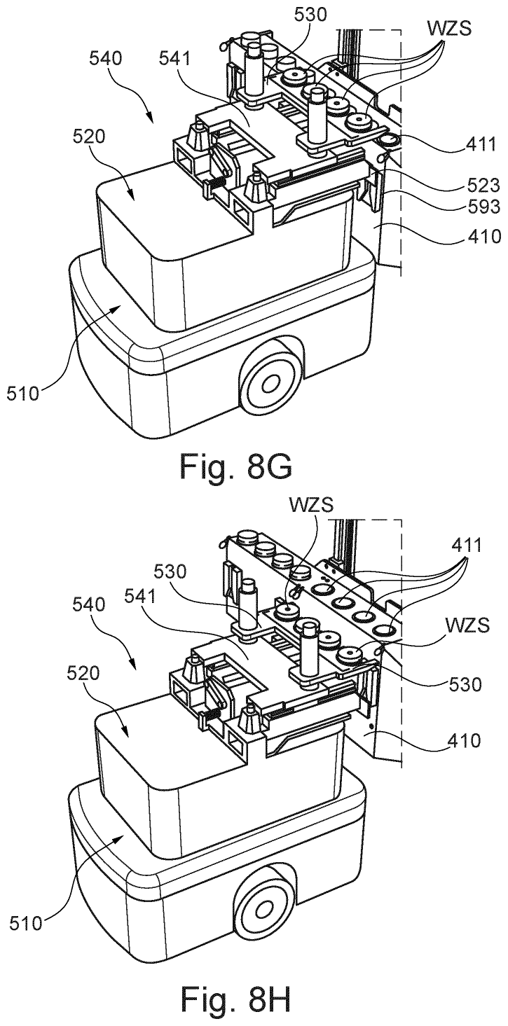

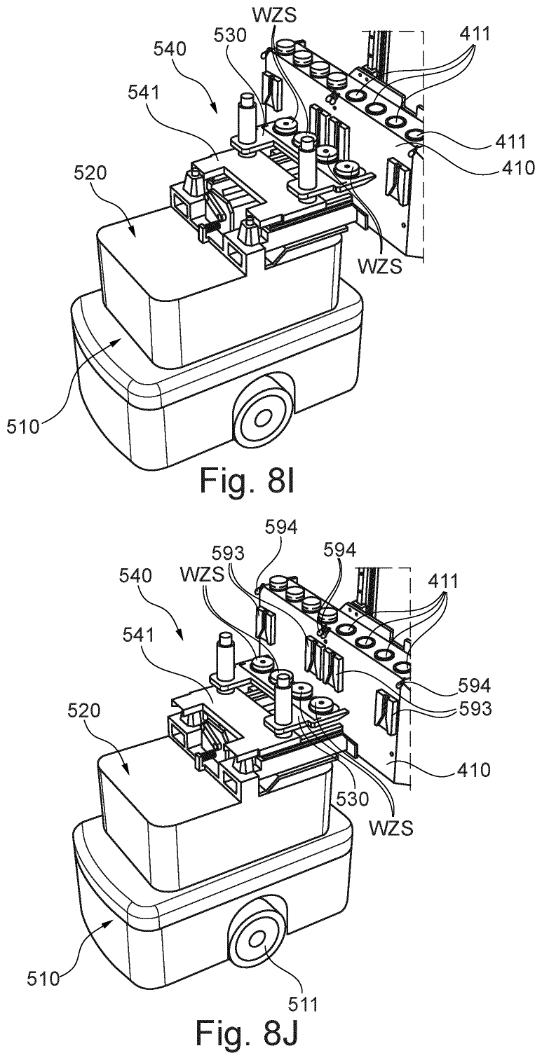

FIGS. 8A to 8J show exemplary perspective illustrations of the supply trolley or transport vehicle according to FIGS. 4A and 4B to illustrate an exemplary unloading process, in particular as an example with a handover unit 540 according to FIGS. 6A to 6F.

Here, the transport vehicle 510 moves to the loading position of the loading bar 410 with an empty tool receiving section 430; see FIG. 8A. The docking process may, for example, similarly to FIGS. 7A to 7F, be performed in the loading process; see FIGS. 8A to 8C.

While the loading bar 410 is moved to a position below the actual transfer level in the loading process in order to move up to the extended tool retaining section 430 from below (see FIGS. 7H and 7I), the loading bar 410 is moved, in the unloading process, directly to the position located at the actual transfer level with the tool retaining section 430 not yet extended or not yet fully extended; see FIG. 8D.

The tool retaining section 430 may now be moved up or close to the tool receptacles 411 of the loading bar 410 by moving the carriage 541 towards the loading bar 410. In this exemplary embodiment, the positioning elements 594 are provided, for precise vertical alignment, on the upper front edge of the loading bar 410 at the level of the tool receptacles 411, on the upper side of which (possibly implemented by means of rollers) the tine sections 530a of the tool retaining section 530, which are tapering towards the front, slide or roll when the tool retaining section 430 is moved toward or over the tool receptacles 411 of the loading bar 410 by moving the carriage 541 toward the loading bar 410; see FIGS. 8D and 8E.

Due to the exemplary vertical mobility of the tool retaining section 530 on the guide sections 541c, an exact relative height positioning of the tool retaining section 530 with respect to the handover height or the height position of the tool receptacles 411 of the loading rail 410 can be provided.

FIG. 8E shows an example of the state in which the tool retaining section 530 has moved completely over the tool receptacles 411 of the loading bar 410 and the retaining sections of the tool retaining section 530 engage, for example, in the gripper grooves of the tool interfaces WZS to be unloaded (similar to the situation in the loading process in FIG. 7I).

If locked, the tool interfaces WZS on the tool retaining section 530 and/or on the tool receptacles 411 may now be unlocked so that the tool interfaces WZS are released from the tool receptacles 411 by moving the loading bar 411 downwards and remain held or are held on the tool retaining section 530; see FIG. 8F.

In FIG. 8G, by way of example, the tool retaining section 530 is retracted away from the loading bar 410 by moving the carriage 541 so that the loading bar 410 can be moved back up if necessary or desired; see FIGS. 8G and 8H. In addition, the transport vehicle 510 may be driven backwards away from the loading position or released from the docking state; see FIGS. 81 and 8J.

In exemplary embodiments, the handover unit 540 may be permanently attached to a transport vehicle 510. In further exemplary embodiments, however, it is particularly expediently possible to provide a handover unit as a modular attachment of a transport system or preferably a driverless transport system, in which a generally provided transport vehicle has one or more interfaces for receiving module attachments and the handover unit 540 is (detachably) disposed or attached as a handover module at an interface of the transport vehicle. Additional modules for workpiece or tool handling or other functions may be provided here.

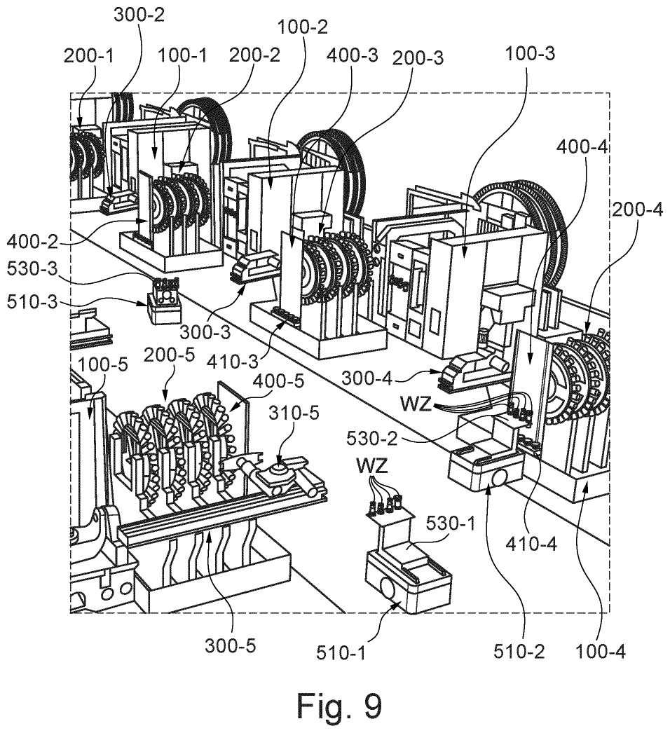

FIG. 9 shows an exemplary perspective view of a production system comprising a plurality of machine tools 100 and a driverless transport system (DTS) with respective unloading or loading devices or driverless transport vehicles 510, for example, according to an exemplary embodiment of the invention.

In particular, FIG. 9 shows an exemplary production system comprising an exemplary row of machine tools 100-1 to 100-4. By way of example, the production system includes a second row of machine tools, such as machine tool 100-5. Between the rows of machine tools 100-1 to 100-5, a travel area or transport area for a driverless transport system (DTS) comprising, for example, a plurality of driverless transport vehicles 510-1 to 510-3 is formed.

In this exemplary embodiment, the driverless transport vehicles 510-1 to 510-3 are configured similarly to the transport vehicle 510 according to FIGS. 1A and 1B. Consequently, the transport vehicles 510-1 to 510-3 include respective tool receiving sections 530-1 to 530-3. In further embodiments, other transport vehicles may additionally or alternatively be used, e.g., in accordance with other embodiments of this present disclosure. Consequently, handover units 540 according to other exemplary embodiments of this present disclosure may be used.

For example, in FIG. 9, the driverless transport vehicle 510-2 is currently docked at the loading position of the supply unit 400-4 of the machine tool 100-4 (e.g. analogous to the docking state according to FIG. 1B), e.g. in order to handover tools WZ received at the tool receiving section 530-2 of the handover unit of the transport vehicle 510-2 on the loading bar 410-4 of the supply unit 400-4 of the machine tool 100-4, wherein said tools WZ may then be loaded on the tool magazine 200-4 of the machine tool 100-4.

By way of example, the machine tools 100-1 to 100-5 according to FIG. 9 include respective tool magazines 200-1 to 200-5, wherein wheel magazines each having four magazine wheels are used, for example. In addition, the machine tools 100-1 to 100-5 according to FIG. 9 include respective supply units 400-1 to 400-5 accessible at corresponding loading positions for the transport vehicles 510-1 to 510-3 and corresponding changing devices 300-1 to 300-5. In the changing device 300-5, the movable manipulator 310-5 is clearly visible in FIG. 9.

It advantageously becomes possible here to provide an automated production system including a plurality of machine tools 100-1 to 100-5 and an associated automated loading or unloading system with a driverless transport system for driverless transport vehicles 510-1 to 510-3 for automated loading and unloading of the machine tools 100-1 to 100-5 with tools (and/or workpieces or components).

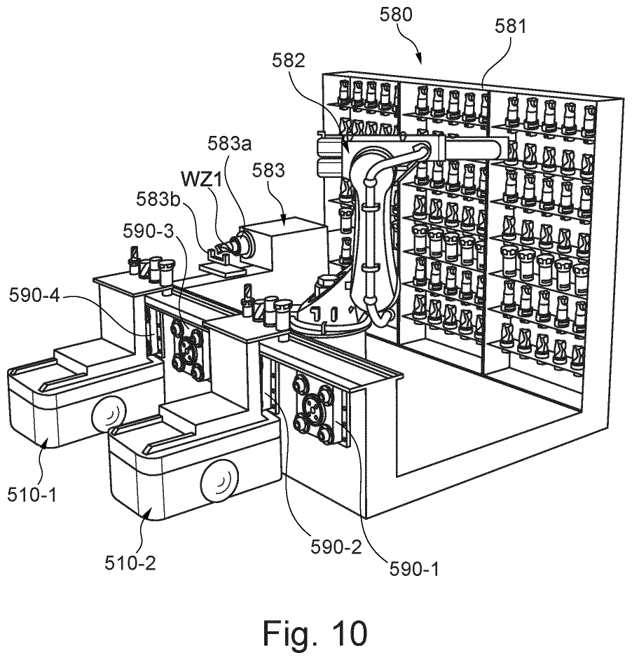

Here, tools and/or workpieces or components loaded or unloaded on the machine tools 100-1 to 100-5 of the production system can be received or deposited at one or more loading stations or supply stations accessible to the driverless transport vehicles 510-1 to 510-3; see e.g. FIG. 10.

FIG. 10 shows an exemplary perspective illustration of a supply station 580 of a production system including a driverless transport system (DTS) with respective unloading or loading devices according to an exemplary embodiment of the invention.

The supply station 580 includes, for example, a shelf magazine 581 for storing tools. In further exemplary embodiments, other magazine types may also be used, e.g. chain magazines, wheel magazines, tower magazines, hybrid magazines, etc. In addition or as an alternative, component magazines or workpiece pallet magazines may be provided.

The supply station 580 includes, for example, docking sections 590-1 to 590-4 with which respective transport vehicles of the driverless transport system (DTS) can dock. By way of example, the transport vehicles 510-1 and 510-2 are docked with the docking sections 590-4 and 590-2 of the supply station 580 (e.g. analogously to the docking state according to FIG. 1B).

In this exemplary embodiment, the driverless transport vehicles 510-1 and 510-2 are configured similarly to the transport vehicle 510 according to FIGS. 1A and 1B. Consequently, the transport vehicles 510-1 and 510-2 include respective front docking sections. In further embodiments, other transport vehicles may additionally or alternatively be used, e.g., in accordance with other embodiments of this present disclosure. Consequently, handover units 540 with docking sections 523 according to other exemplary embodiments of this present disclosure may be used.

For example, the supply station 580 includes a handling robot 582 configured to remove tools (and/or workpieces) from the magazine 581 and to deposit or insert them at receiving sections of the transport vehicles 510-1 and 510-2 docked at the docking sections 590-1 to 590-2. Furthermore, the handling robot 582 may additionally or alternatively be configured to receive tools and/or workpieces on receiving sections of the transport vehicles 510-1 and 510-2 docked at the docking sections 590-1 to 590-2 and to deposit them on the magazine 581.

For example, the supply station 580 includes a measuring unit 583 with a receptacle 583a and a measuring instrument 583b. In preferred exemplary embodiments, it may be possible for the robot 582 to be configured to insert tools (and/or workpieces), which were received, for example, in the magazine 581 or in a receiving section of a docked transport vehicle, on the receptacle 583 or to receive them on the receptacle 583a and to deposit them in the magazine 581 or on a receiving section of a docked transport vehicle.

For example, the measuring unit 583 of the supply station 580 is configured to measure a tool WZ1 (or a workpiece) held on the receptacle 583a with the measuring instrument 583b, e.g. optically using a laser measuring unit and/or a camera. Furthermore, the receptacle 583a may be configured to rotate the tool WZ1 (or a workpiece) held on the receptacle 583a about an axis of rotation (e.g. about the tool axis of a rotationally symmetrical drilling and/or milling tool), possibly to measure the tool WZ1 or tool contour.

Furthermore, the measuring unit 583 may be configured, for a measuring process, to move and/or rotate or pivot the receptacle 583a relative to the measuring instrument 583b or the measuring instrument 583a relative to the receptacle 583a in one, two or three spatial directions. In this case, the measuring unit 583 may be equipped with the full range of functions of a tool presetting device. However, it is also possible to provide independent measuring unit or presetting unit stations that can be approached by transport vehicles.

It should also be mentioned here that advantageous exemplary embodiments may be provided in which docked transport vehicles (e.g. via the connected data interface in the docked state or also via wireless signal transmission, e.g. via RFID, WLAN, Bluetooth or radio) can read information measured on the measuring unit 583 as a tool and/or workpiece data. It is possible, for example, for the transport vehicle 510-1 in FIG. 4 to read tool data about the tool WZ1 measured on the measuring unit 583 via the data interface of the docking section 590-4. Such a data readout function may also be made possible for independent measuring unit or presetting unit stations that can be approached by transport vehicles.

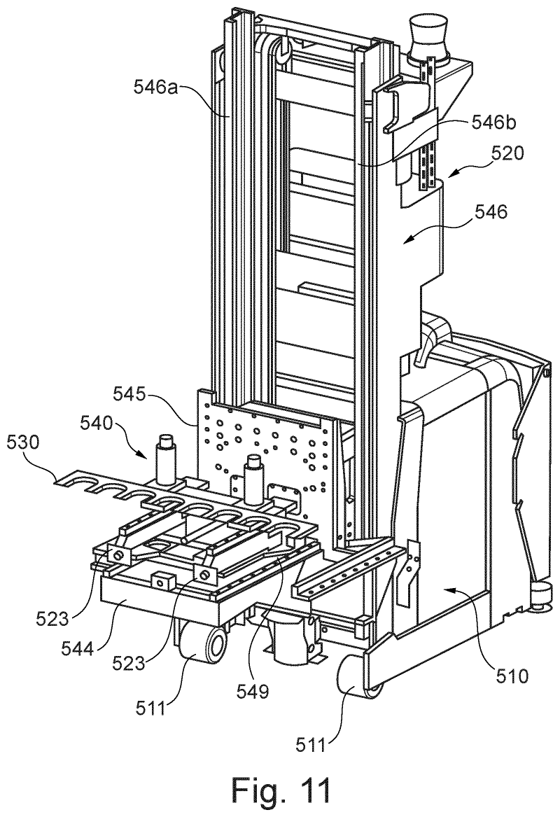

FIG. 11 shows an exemplary perspective illustration of a further exemplary embodiment of a supply vehicle or transport vehicle 510 of an unloading or loading device according to an exemplary embodiment of the invention. Here, the transport vehicle 510 according to FIG. 11 may be configured, for example, as a driverless forklift truck with an additional lifting axis.

The transport vehicle 510 according to FIG. 11 includes, for example, a handover unit 540 analogous to FIGS. 6A through 6F. Here, however, in contrast to FIGS. 6A to 6F, the receiving section 530 is configured with eight (instead of four) retaining sections for tools (and/or workpieces) so that a loading bar having eight receptacles can be loaded or unloaded in one loading or unloading process.

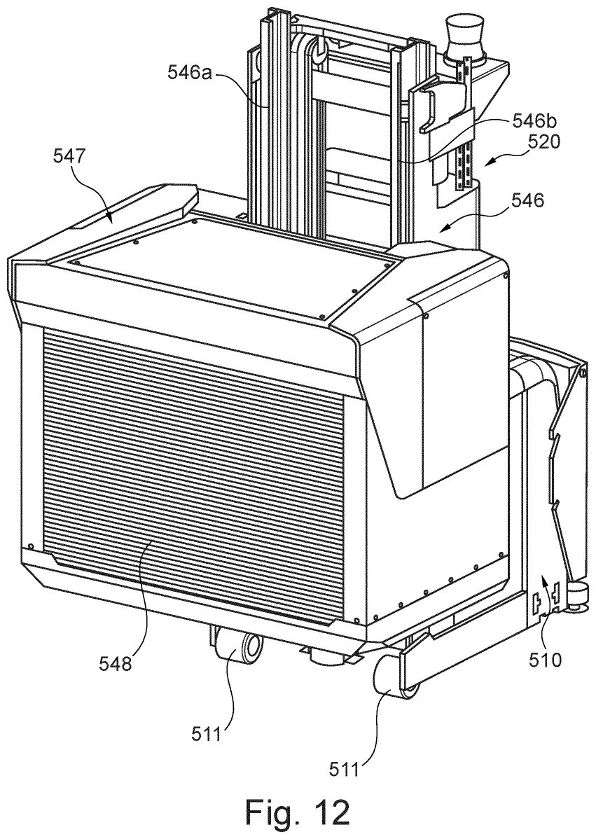

By way of example, the handover unit 540 in FIG. 11 includes a further (optional) horizontal linear axis (in particular in the docking direction or parallel to the linear axis of the carriage 541) by, for example, the carrier section 544 having a further carriage 549 which moves the handover unit 540 to the loading position of the supply unit, or in particular in the docking direction or in parallel to the linear axis of the carriage 541. This is particularly advantageous when a protective cabin is additionally provided to cover the handover unit 540 during transport (see, e.g., FIG. 12).

For example, the unloading and loading device 520 on the transport vehicle 510 according to FIG. 11 includes a lifting section 546 which, on the front side, has vertical guides 546a and 546b on which a lifting carriage 545 is mounted such that it can be moved vertically.

The lifting carriage 545 carries (e.g. with a lifting fork or another form of carrier) the handover unit 540 with docking sections 523 pointing forward, for example. In particular, the lifting carriage 545 carries the carrier section 544 of the handover unit 540. The carrier section 544 may be detachably attached to the lifting carriage 545 or it may also be attached in a fixed manner.

The additional lifting axis has the particular advantage that different machine tools can be loaded and unloaded with loading positions of the corresponding supply units 400 arranged at different heights.

It should be noted that a vertical lifting axis for moving the receiving section 530 vertically in other exemplary embodiments (e.g., in the transport vehicle according to FIGS. 1A and 1C or the transport vehicle according to FIGS. 4A and 4B) may also be provided by a lifting mechanism provided on the wheels 511, which may raise and lower the transport vehicle as a whole.

FIG. 12 shows an exemplary perspective illustration of a further exemplary embodiment of a supply trolley or transport vehicle 510 of an unloading or loading device according to an exemplary embodiment of the invention.

By way of example, the transport vehicle 510 in FIG. 12 is provided analogously to FIG. 11, with the transport vehicle 510 including, for example, an additional protective housing 547 (protective cabin) receiving or accommodating the handover unit 540 according to FIG. 11. When the openable or closable roller door 548 is open or is opened after transport, the handover unit 540 may be docked with the docking sections at the loading position of the supply unit, possibly after moving the carrier section 545 towards the loading position (e.g. by means of the horizontal linear axis of the carriage 549 according to FIG. 11).

In the above exemplary embodiments, the handover unit or docking sections thereof are respectively arranged on the front side of the transport vehicle (in particular with respect to a main direction of travel of the transport vehicle) or are oriented facing forwards. In further exemplary embodiments, however, it is possible to arrange the handover unit or docking sections thereof on the side of the transport vehicle or to orient them facing to the side. In such exemplary embodiments, the transport vehicle may then, for example, approach the loading position from the side. The last docking movement to the loading position may then possibly be performed transversely to the main direction of travel of the transport vehicle towards the side. However, it is also possible to provide docking sections that dock with docking sections at the loading position sideways.

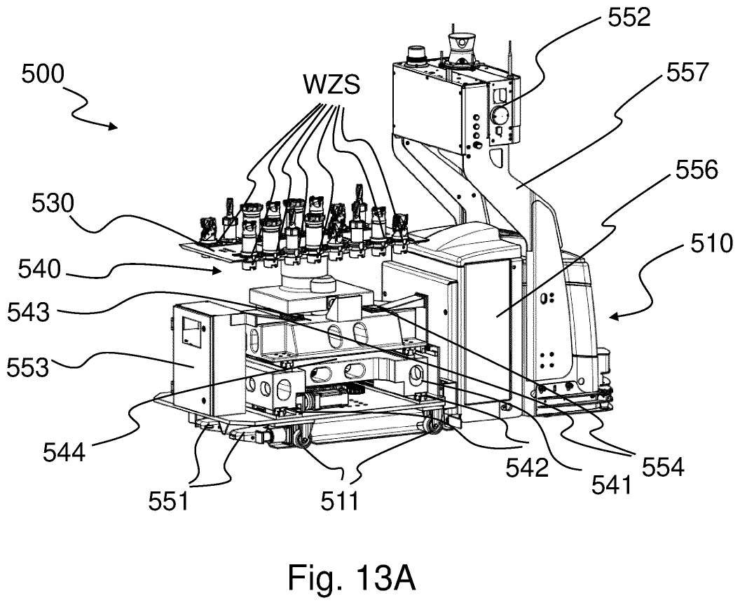

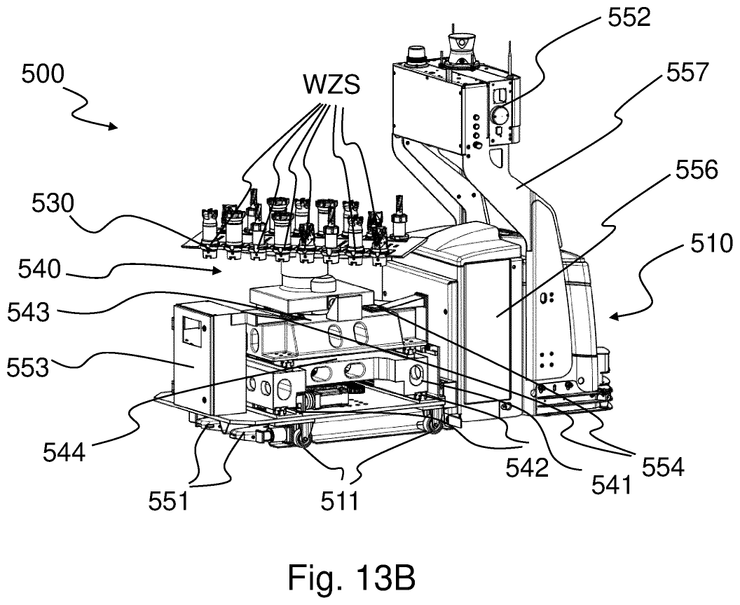

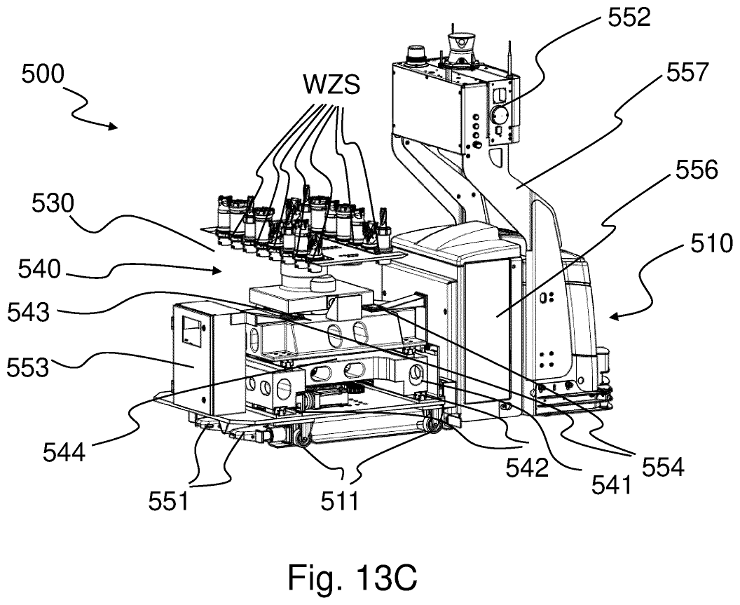

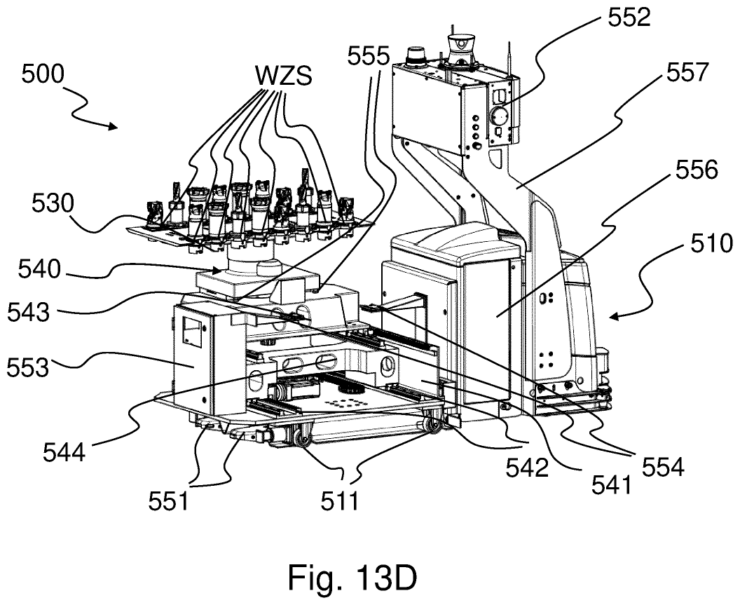

FIGS. 13A to 13D show an exemplary perspective illustration of a further exemplary embodiment of a supply trolley or transport vehicle 510 of an unloading or loading device 500 of the invention.

In analogy to the exemplary embodiment according to FIGS. 1A and 1B, the transport vehicle is configured as an example of a driverless transport vehicle 510, wherein, in this case, similar to the exemplary embodiment of FIG. 11, the basic structure thereof is defined by a trackless industrial truck, such as a forklift or a lift truck to be controlled electronically.

The transport vehicle 510 according to FIGS. 13A to 13D includes, for example, a chassis 556 located at the rear part of the transport vehicle 510, in which, for example, electronic control systems, regulators and drive motors may be positioned and optimally protected from any external influences. In addition, the chassis 556 is connected, via a vertically oriented framework 557, to a control device 552, for example, by which the automatic control or automation of the transport vehicle 510, but also of the entire tool changing process at the supply unit, can be realized by means of a wireless or network connection, analogously to the exemplary embodiment according to FIGS. 4A and 4B.

Also attached to the front of chassis 556 of the transport vehicle 510 are, for example, two forks 551 (e.g., with integrated wheels 511) which are oriented toward the front or in the direction of travel and to which the handover unit 540 can be connected to the transport vehicle 510 directly or via a contacting plate, preferably detachably, or permanently. By way of example, the forks 551 may also be configured with an additional vertical lifting axis, analogously to the exemplary embodiment according to FIG. 11, such that the handover unit 540 is mounted so as to be vertically displaceable at least via the movement of the forks 551,

Transverse to the orientation of the forks 551, two horizontal linear guides 542 are attached, for example, to the forks 551 or a contacting plate resting on the forks 551, said linear guides 551 making it possible, via two guide carriages 541 positioned laterally on second support section 544, to move the handover unit 540 laterally, preferably evenly towards both sides (see comparison FIGS. 13A and 13D). For example, the movement of the handover unit 540 by this linear guide may be used in particular for the rapid approach of the handover unit 540 to the respective supply unit.

On the second carrier section 544, which is connected to the transport vehicle 510 by the linear guide 542, the first carrier section 543 is also positioned, for example, so that it can move independently via a further guide rail 558 oriented in parallel to the aforementioned linear guide 542, so that both the second carrier section 544 via the first-mentioned linear guide 542 and the first carrier section via the guide rail 558 described herein can be moved simultaneously. By moving the first 543 and the second carrier section 544 in parallel, the handover unit 540 connected thereto can advantageously be brought closer to the supply unit. In particular, the movement of the two carrier sections 543, 544 may be configured in such a way that the second, lower carrier section 544 can be used to quickly and broadly approach the handover unit 540, for example by means of a powerful carriage drive 550, and the first carrier section 543 resting thereon can be used to finely adjust the handover unit 540, for example with the help of a fine drive built into the linear guide rail 558.

For example, for more precise positioning of the handover unit 540, the first carrier section 543 includes snap-in elements 555, which may be enclosed flush with snap-in holders 554 positioned on the front and rear of the forks 551 or the contacting plate on a snap-in holder frame 553, and thus can fix at least the movement of the first carrier section 543 completely. These snap-in holders 554 are preferably also movable in parallel to the linear guide rails 558. The snap-in holder frame 553 on the front of the transport vehicle 510 or the forks 551 also includes sensors, for example, such as optical, mechanical or electrical sensors, such as a light barrier or an inductively controlled rangefinder, which measure the distance between the snap-in elements 555 and the snap-in holder 554 and can forward it to the respective drives of the guide rail 558 or the linear guide 542 for precise positioning.

In addition, in this exemplary embodiment, the docking sections 523 of the unloading and loading device 500 are attached laterally to the first carrier section 543, for example, so that, by moving the transport vehicle 510 up to the supply unit from the side and moving the first 543 and second carrier section 544 by means of the guide rail 558 and the linear guide 542, the docking sections 523 of the loading and unloading device 500 can dock appropriately to the docking sections of the supply unit.

For example, the connection of the docking sections 523 of the unloading and loading device 510 and the supply unit may be used, analogously to the exemplary embodiments according to FIG. 1A, for data transmission of tool data or information and for fixing the loading and unloading device 510 in particular in the direction of travel, i.e. preferably forwards, in parallel to the orientation of the forks 551.

For example, the handover unit 540 is attached centrally and detachably or permanently to the first carrier section 543 so that the handover unit 540 is also moved by moving the first 543 and second carrier sections 544 and can thus be positioned in the direction of the supply unit. In this exemplary embodiment, the handover unit 540 comprises, in particular, a receiving section 530, which is provided with two rows of retaining sections oriented opposite one another, includes a gripper bar and can be rotated by any desired angle of rotation in the horizontal plane via a rotary device or a rotary bearing (see FIGS. 13A to 13C with the respective angle of rotation of 0°, 45° and 90°). This rotational movement has the advantage, among others, that a flexible handover of the tools can be performed and a larger number of tools can be received or a larger number of retaining sections can be introduced into the receiving section 530 of the handover unit 540 and, by simply rotating the retaining sections rows both the handover of tools stored on the unloading and loading device 500 as well as the pick-up of tools provided, for example, at the supply unit can be performed by a single loading and unloading device 500.

By way of example, the tool, analogously to the exemplary embodiment according to FIG. 1A, is oriented vertically on the retaining sections of the receiving section 530 and is mounted on the tool interfaces WZS. In addition, the receiving section 530 is not limited to two opposite rows of retaining sections due to the angle of rotation (preferably more than 180° and particularly preferably more than 360°), but may have all kinds of possible retaining section arrangements and geometries.

Furthermore, the rotary bearing of the handover unit 540 is provided with its own lifting mechanism, for example, so that, analogously to the tool changing process according to FIGS. 7A to 7J or 8A to 8J, the handover unit 540 can pick up the tools from the supply unit by lifting the tools enclosed by the gripper bar or hand over the tools to the respective supply unit by lowering them into the retaining sections of the supply unit. The linear guide 542 of the second carrier section 544 and the guide rail 558 of the first carrier section 543 take over the movement of the retaining sections analogously to the guides 432, 431 exemplarily shown in FIGS. 5A and 5B.

In the above exemplary embodiments, the handover unit or docking sections thereof are each arranged on the front side of the transport vehicle (in particular in relation to a main direction of travel of the transport vehicle) or are oriented pointing forwards. In further exemplary embodiments, however, it is possible to arrange the handover unit or docking sections thereof on the side of the transport vehicle or to orient them pointing to the side. In such exemplary embodiments, the transport vehicle may then, for example, approach the loading position from the side. The last docking movement may then possibly be performed transversely to the main direction of travel of the transport vehicle to the side towards the loading position. However, it is also possible to provide docking sections that dock with docking sections at the loading position sideways.

In the above exemplary embodiments, workpiece and/or tool loading on the machine tool that is fast, precise and efficient and partially or fully automated can be provided. In addition, in optional embodiments, mechanisms to enable precise alignment of the tool retaining section of the handover unit relative to the loading bar may be provided, in particular with regard to:
an optional preferred alignment in depth or in the direction towards the loading bar, e.g. by the abutting contact of the docking elements of the handover unit with docking elements of the loading bar or a docking section in front of the loading bar;
an optional preferred lateral alignment laterally or in the transverse direction of the handover unit (or longitudinal direction of the loading bar), e.g. by form-fitting or locking the docking elements and/or guiding the docking elements 524 of the docking sections 523 of the handover unit in vertically extending contour sections of docking elements or docking stops on the loading bar side; and/or
an optional preferred alignment in height, e.g. by form-fitting or locking the docking elements and/or guiding sections of a tool retaining section of the handover unit, which is mounted so as to be movable in height, to positioning elements on the loading bar.

Examples or exemplary embodiments of the present invention and their modifications and advantages have been described in detail above with reference to the attached figures. It should be emphasized again that the present invention is in no way limited or restricted to the exemplary embodiments described above and their design features, but also includes modifications of the exemplary embodiments, in particular those that are obtained by modifying the features of the examples described or by combining individual or more of the features of the described examples are included within the scope of the independent claims.

In summary, the aspects or features of the present invention and in particular, but not conclusively, the aspects or features of the exemplary embodiments described make it possible to provide improved, more efficient and/or more precise workpiece or tool loading on a machine tool, in particular particularly expediently with further improved or expanded automation of the loading or unloading process or particularly preferably with a fully automated configuration through the use of a fully automated driverless transport vehicle.

1. An unloading or loading device for use on a machine tool, the unloading or loading device comprising:
a transport vehicle that can be moved freely on a base area;
a handover unit arranged on the transport vehicle and including a receiving section having a plurality of retaining sections arranged in a row for receiving tools or tool interfaces holding tools and/or workpieces; and
one or more docking sections arranged on the transport vehicle for docking with one or more docking sections of a supply unit for tools and/or workpieces on the machine tool, including a supply unit of a tool and/or workpiece magazine of the machine tool.

2. The unloading or loading device according to claim 1, characterized in that the row of retaining sections of the receiving section extends in a transverse direction with respect to the transport vehicle or transversely to a direction of travel of the transport vehicle, the retaining sections being arranged next to one another in a row in the transverse direction or in a direction transverse to the direction of travel of the transport vehicle.

3. The unloading or loading device according to claim 1, characterized in that the transport vehicle is configured, for docking to the docking section(s) of the supply unit, to approach the docking section(s) of the supply unit in a direction of travel, with regard to which the row of retaining sections of the receiving section is oriented transversely, with the retaining section(s) facing towards the docking section(s) of the supply unit and/or the docking section(s) of the transport vehicle facing towards the docking section(s) of the supply unit.

4. The unloading or loading device according to claim 1, characterized in that the docking section(s) of the transport vehicle are configured to dock with corresponding docking section(s) of the supply unit when the transport vehicle is approaching the docking section(s) of the supply unit with the retaining section(s) facing the docking section(s) of the supply unit and/or the docking sections of the transport vehicle facing the docking sections of the supply unit.

5. The unloading or loading device according to claim 4, characterized in that the docking section(s) of the transport vehicle are configured to dock with the corresponding docking section(s) of the supply unit via a mechanical connection and/or a stop contact blocking at least one movement in a direction of travel of the transport vehicle, including while blocking in a form-fitting manner in the direction of travel,
wherein a position alignment of the handover unit in the direction of travel of the transport vehicle can be achieved in a docked state.

6. The unloading or loading device according to claim 4, characterized in that the docking section(s) of the transport vehicle are configured to dock with the corresponding docking section(s) of the supply unit via a mechanical connection blocking at least one horizontal movement transverse to a direction of travel of the transport vehicle, while blocking horizontally laterally or transversely to the direction of travel, wherein, in a docked state, a lateral position alignment of the handover unit transversely to the direction of travel of the transport vehicle can be achieved.

7. The unloading or loading device according to claim 4, characterized in that the docking section(s) of the transport vehicle are configured to dock with the corresponding docking section(s) of the supply unit via a mechanical connection blocking in one or more directions transverse to the direction of travel of the transport vehicle, while blocking in a form-fitting manner transverse to the direction of travel, wherein, in a docked state, a position alignment of the handover unit in one or more directions transverse to the direction of travel of the transport vehicle can be achieved.

8. The unloading or loading device according to claim 4, characterized in that the docking section(s) of the transport vehicle are configured to dock with the corresponding docking section(s) of the supply unit via a mechanical connection that can be unlocked and locked, while blocking in a form-fitting manner transversely to a direction of travel, wherein, in a docked state, a positional locking of the handover unit can be achieved.

9. The unloading or loading device according to claim 1, characterized in that the handover unit includes a carriage, which can be moved linearly in a direction of travel of the transport vehicle and/or in a direction transverse to the row of retaining sections of the receiving section and which carries the receiving section, for moving the receiving section towards and away from the supply unit in a docked state.

10. The unloading or loading device according to claim 9, characterized in that the handover unit includes stopper sections, guide sections and/or docking elements, including stopper sections, guide sections and/or docking elements connecting in a form-fitting manner which block a movement of the carriage in a self-centered and/or locked transport state, in a direction opposite the direction of travel of the transport vehicle.

11. The unloading or loading device according to claim 1, characterized in that the handover unit includes a first carrier section which carries the receiving section directly or indirectly, via a movable carriage which is carried by the first carrier section and carries the receiving section.

12. The unloading or loading device according to claim 1, characterized in that the handover unit includes a second carrier section arranged or attached to the transport vehicle in a stationary manner with respect to the docking section(s) of the transport vehicle.

13. The unloading and loading device according to claim 12, characterized in that:
the second carrier section carries the first carrier section; and/or
the first carrier section is mounted on the second carrier section such that is mounted in a floating manner so that it can be moved in at least one horizontal direction and/or so that it can be moved in at least one horizontal direction.

14. The unloading or loading device according to claim 13, characterized in that the first carrier section is mounted on the second carrier section in a movably floating and/or movable manner, at least in the direction of travel of the transport vehicle.

15. The unloading or loading device according to claim 14, characterized in that the handover unit includes stopper sections, guide sections and/or docking elements, including stopper sections, guide sections and/or docking elements connecting in a form-fitting manner which allow for a movement of the first carrier section relative to the second carrier section in the direction of travel of the transport vehicle in a locked transport state.

16. The unloading or loading device according to claim 13, characterized in that the first carrier section is mounted in a floating manner on the second carrier section so as to be movable at least transversely to the direction of travel of the transport vehicle.

17. The unloading and loading device according to claim 16, characterized in that the handover unit includes stopper sections, guide sections and/or docking elements, including stopper sections, guide sections and/or docking elements connecting in a form-fitting manner which block a movement of the first carrier section relative to the second carrier section perpendicular to the direction of travel of the transport vehicle in a self-centered and/or locked transport state.

18. The unloading or loading device according to claim 15, characterized in that the handover unit includes a biasing mechanism which biases the first carrier section relative to the second carrier section in a self-centered and/or locked transport state or exerts a force acting on the second carrier section towards a position of the second carrier section that brings about the self-centered and/or locked transport state.

19. The unloading or loading device according to claim 1, characterized in that the transport vehicle is configured as a driverless transport vehicle, the transport vehicle including a control unit for driverless control of the transport vehicle and/or a communication unit for wireless connection to an external control unit.

20. The unloading or loading device according to claim 1, characterized in that the transport vehicle is at least translationally driven, by a drive for a translational movement of the transport vehicle.

21. The unloading or loading device according to claim 1, characterized in that the transport vehicle has automated steering assistance and/or steering control.

22. A system comprising a supply unit for use on a tool and/or workpiece magazine for a machine tool and an unloading or loading device according to claim 1.

23. The system according to claim 22, characterized in that the transport vehicle of the unloading or loading device is configured to dock with one or more docking sections of the supply unit for loading or unloading a loading bar of the supply unit, in a partially or fully automated manner.

24. The system according to claim 22, characterized in that:
the supply unit includes a loading bar that can be brought into a loading position and includes a row of workpiece and/or tool receptacles; and
wherein the handover unit of the unloading or loading device is configured, in a docked state, to handover or insert and/or receive or pick up workpieces and/or tools on the workpiece and/or tool receptacles of the loading bar at the loading position, in a partially or fully automated manner.
